(19) United States
(12) Patent Application Publication
(10) Pub. No.: US 2025/0322612 A1
(43) Pub. Date: Oct. 16, 2025

(54) ESTABLISHING SPATIAL TRUTH FOR SPATIAL GROUPS IN MULTI-USER COMMUNICATION SESSIONS

(71) Applicant: Apple Inc., Cupertino, CA (US)

(72) Inventors: Joseph P. CERRA, San Francisco, CA (US); Peter F. HANDEL, San Jose, CA (US); Praveen SHARMA, Brooklyn, NY (US); Patrick PIEMONTE, San Francisco, CA (US)

(21) Appl. No.: 19/079,152

(22) Filed: Mar. 13, 2025

Related U.S. Application Data
(60) Provisional application No. 63/634,168, filed on Apr. 15, 2024.

(51) Int. Cl. G06T 19/00; G06F 3/14; G06T 7/73; H04L 65/1093

(52) U.S. Cl. CPC G06T 19/00; G06F 3/1454; G06T 7/74; H04L 65/1093; G06T 2219/024

(57) ABSTRACT

Some examples of the disclosure are directed to systems and methods for establishing spatial truth for collocated participants in a multi-user communication session. In some examples, a first electronic device detects an indication of a request to engage in a shared activity with a second, collocated, electronic device. In some examples, the first electronic device determines a first origin according to which content is presented in a three-dimensional environment, wherein the first origin corresponds to a first physical location. In some examples, the first electronic device presents an object corresponding to the shared activity relative to the first origin. In some examples, the first electronic device generates a spatial map of the three-dimensional environment that includes a second origin corresponding to a second, different physical location. In some examples, the first electronic device updates presentation of the object corresponding to the shared activity to be relative to the second origin.

### CROSS-REFERENCE TO RELATED APPLICATIONS

This application claims the benefit of U.S. Provisional Application No. 63/634,168, filed Apr. 15, 2024, the entire disclosure of which is herein incorporated by reference for all purposes.

### FIELD OF THE DISCLOSURE

This relates generally to systems and methods of establishing spatial truth in multi-user communication sessions including participants who are collocated in a same physical environment.

### BACKGROUND OF THE DISCLOSURE

Some computer graphical environments provide two-dimensional and/or three-dimensional environments where at least some objects displayed for a user's viewing are virtual and generated by a computer. In some examples, the three-dimensional environments are presented by multiple devices communicating in a multi-user communication session. In some examples, an avatar (e.g., a representation) of each non-collocated user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for establishing spatial truth for collocated participants within a spatial group in a multi-user communication session. In some examples, a first electronic device is in communication with one or more displays and one or more input devices, wherein the first electronic device is collocated with a second electronic device in a physical environment. In some examples, the first electronic device detects an indication of a request to engage in a shared activity with the second electronic device. In some examples, in response to detecting the indication, the first electronic device determines a first origin according to which content is presented in a three-dimensional environment, wherein the first origin corresponds to a first location in the physical environment. In some examples, the first electronic device enters a communication session with the second electronic device, including presenting, via the one or more displays, an object corresponding to the shared activity in the three-dimensional environment relative to the first origin. In some examples, while in the communication session with the second electronic device and while presenting the object relative to the first origin, the first electronic device generates, based on the physical environment, a spatial map of the three-dimensional environment that includes a second origin corresponding to a second location in the physical environment, the second location different from the first location. In some examples, after generating the spatial map of the three-dimensional environment, the first electronic device updates presentation of the object corresponding to the shared activity in the three-dimensional environment to be relative to the second origin.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4I illustrate exemplary techniques for establishing spatial truth for collocated participants within a spatial group in a multi-user communication session according to some examples of the disclosure.

FIGS. 5A-5H illustrate exemplary techniques for reestablishing spatial truth for collocated participants within a spatial group in a multi-user communication session according to some examples of the disclosure.

FIG. 6 illustrates a flow diagram illustrating an example process for establishing spatial truth for collocated participants in a spatial group in a multi-user communication session according to some examples of the disclosure.

### DETAILED DESCRIPTION

Some examples of the disclosure are directed to systems and methods for establishing spatial truth for collocated participants within a spatial group in a multi-user communication session. In some examples, a first electronic device is in communication with one or more displays and one or more input devices, wherein the first electronic device is collocated with a second electronic device in a physical environment. In some examples, the first electronic device detects an indication of a request to engage in a shared activity with the second electronic device. In some examples, in response to detecting the indication, the first electronic device determines a first origin according to which content is presented in a three-dimensional environment, wherein the first origin corresponds to a first location in the physical environment. In some examples, the first electronic device enters a communication session with the second electronic device, including presenting, via the one or more displays, an object corresponding to the shared activity in the three-dimensional environment relative to the first origin. In some examples, while in the communication session with the second electronic device and while presenting the object relative to the first origin, the first electronic device generates, based on the physical environment, a spatial map of the three-dimensional environment that includes a second origin corresponding to a second location in the physical environment, the second location different from the first location. In some examples, after generating the spatial map of the three-dimensional environment, the first electronic device updates presentation of the object corresponding to the shared activity in the three-dimensional environment to be relative to the second origin.

As used herein, a spatial group corresponds to a group or number of participants (e.g., users) in a multi-user communication session. In some examples, a spatial group in the multi-user communication session has a spatial arrangement that dictates locations of users and content that are located in the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

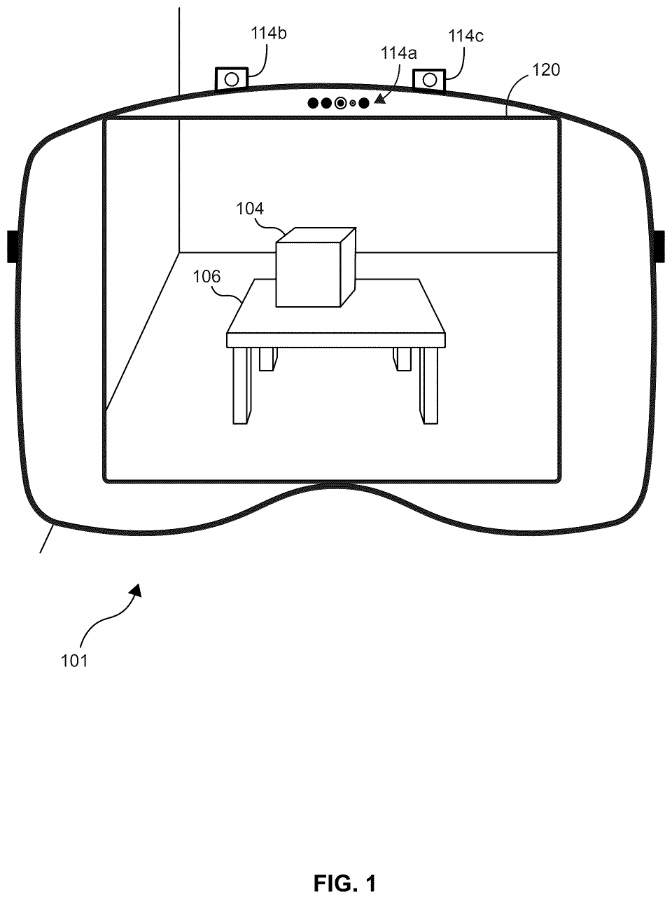

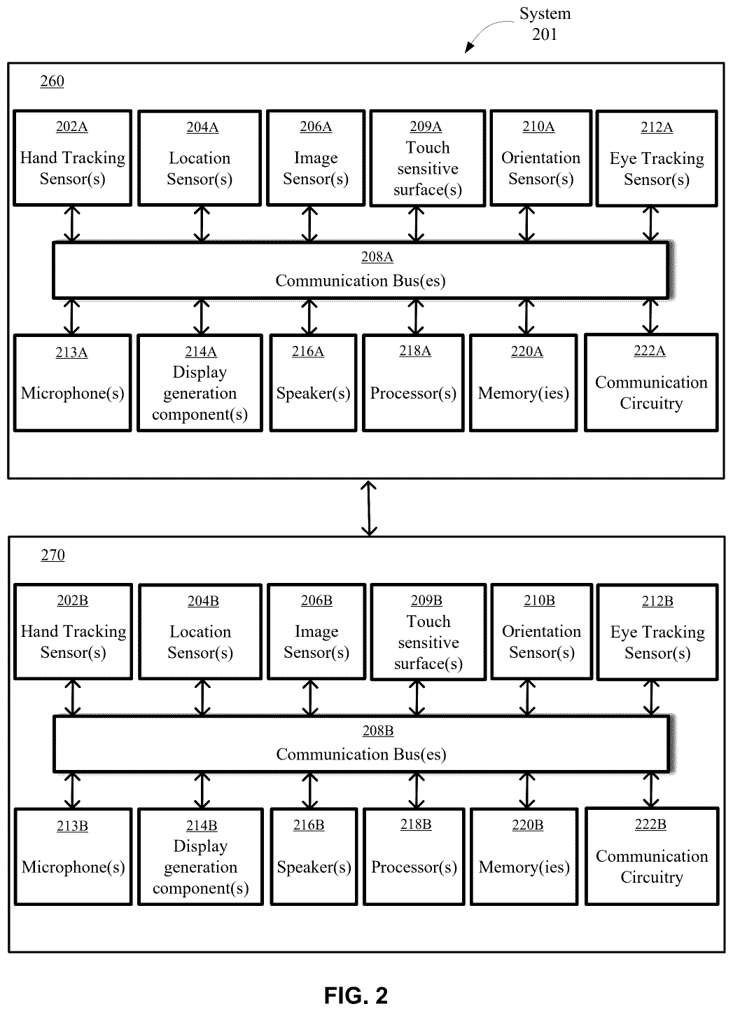

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second electronic device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. A person or persons using system 201, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

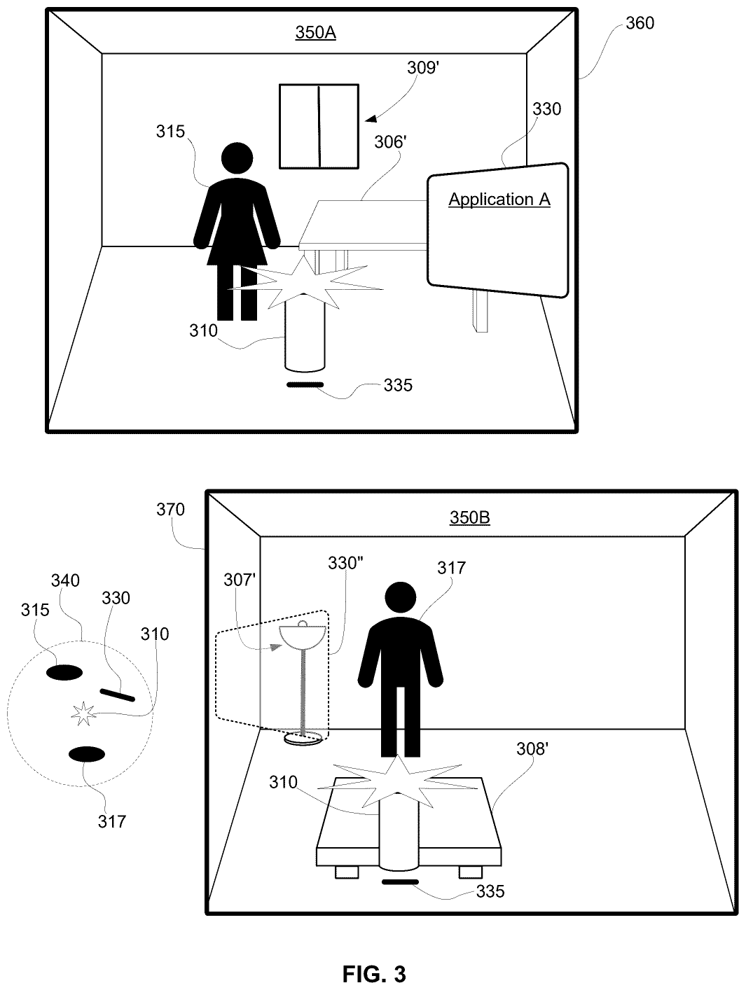

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are representations (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are user-personalized, user-selected, and/or user-created representations displayed in the three-dimensional environments 350A/350B that are representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for facilitating a multi-user communication session that includes collocated users (e.g., collocated electronic devices associated with the users). For example, it may be desirable to enable users who are collocated in a first physical environment to establish a multi-user communication session, such that virtual content may be shared and presented in a three-dimensional environment that is optionally viewable by and/or interactive to the collocated users in the multi-user communication session. As used herein, relative to a first electronic device, a collocated user corresponds to a local user. In some examples, as discussed below, the presentation of virtual objects (e.g., avatars and shared virtual content) in the three-dimensional environment within a multi-user communication session that includes collocated users (e.g., relative to a first electronic device) is based on establishing a shared coordinate space/system based on at least the positions and/or orientations of the collocated users in a physical environment of the first electronic device. Particularly, unlike a multi-user communication session comprised of solely remote users (e.g., non-collocated users) in which an origin of the three-dimensional environment (e.g., according to which content is presented) is able to be determined/placed at any location relative to a first user's physical environment, a multi-user communication session that comprises collocated users requires agreement and/or collaboration between the electronic devices on the placement of the origin of the three-dimensional environment. For example, as discussed herein, because collocated users are represented in the multi-user communication session by their physical bodies that are not freely movable by the first electronic device (e.g., as opposed to avatars which are freely movable), the origin of the three-dimensional environment need be agreed upon by the electronic devices in the multi-user communication session.

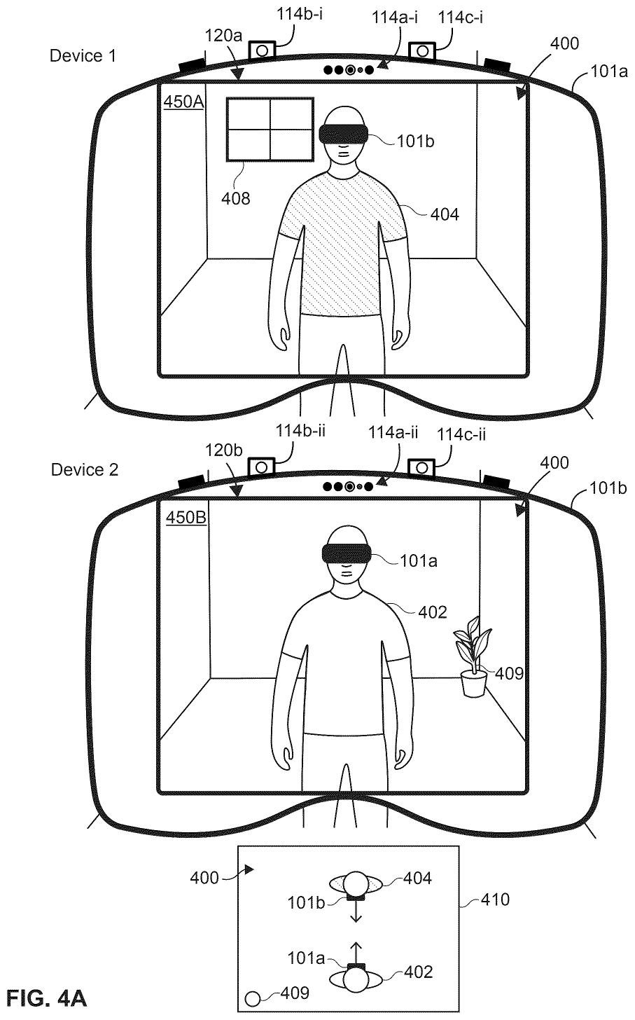

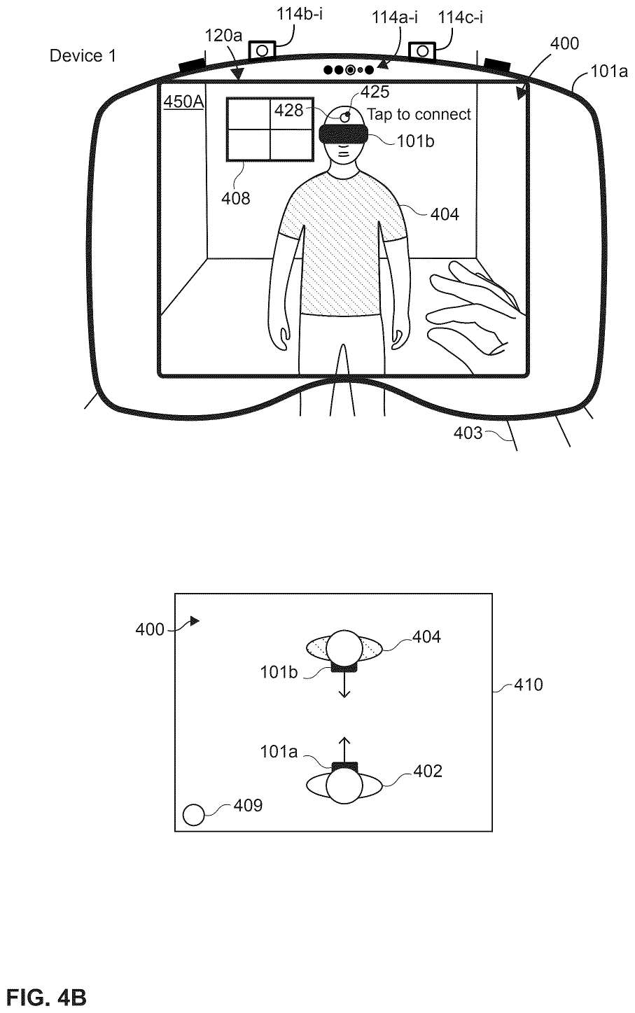

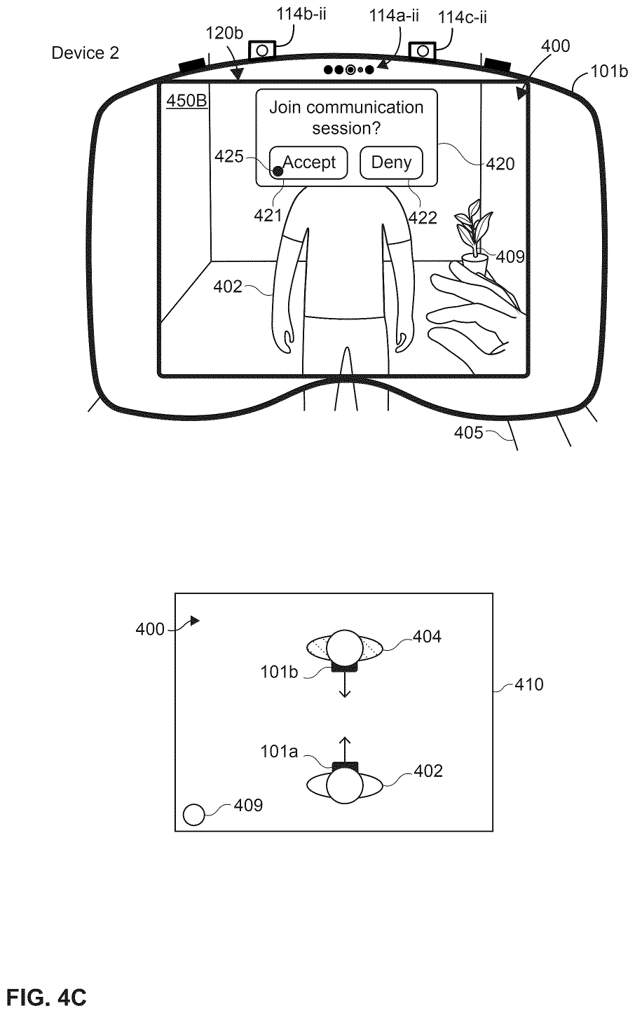

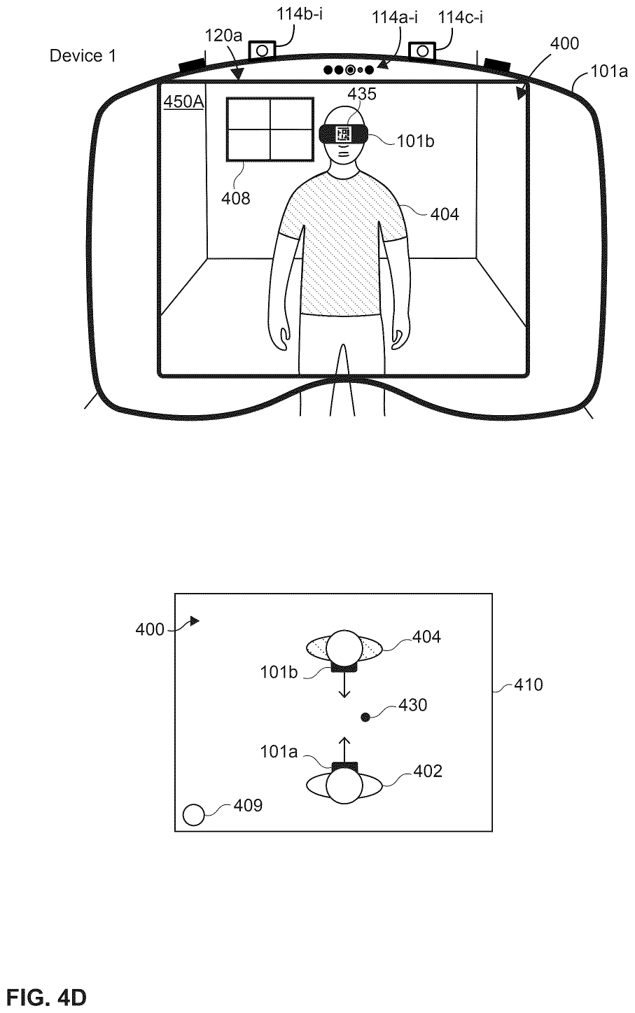

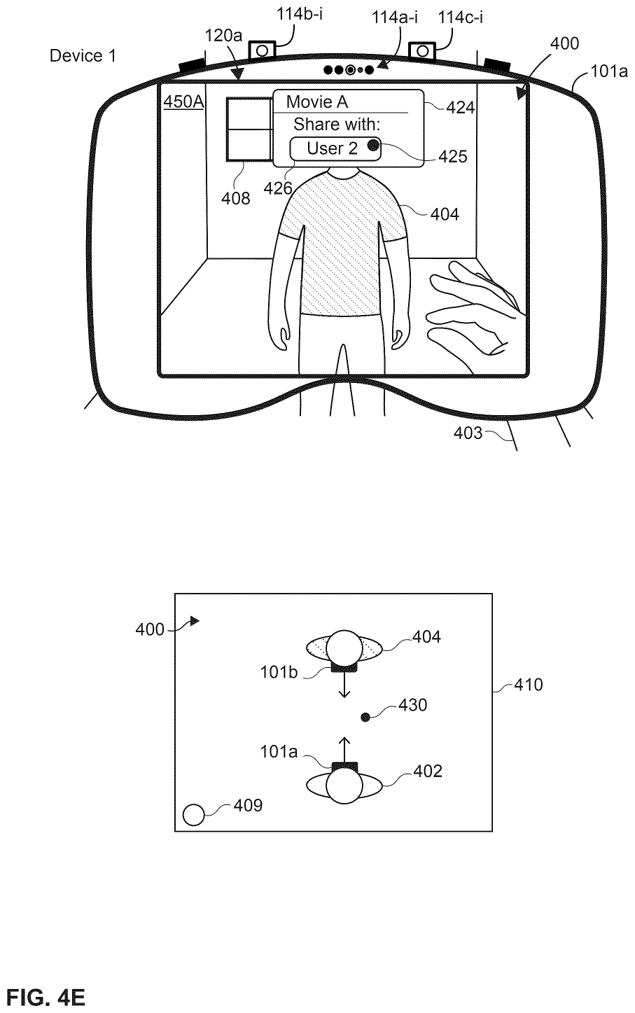

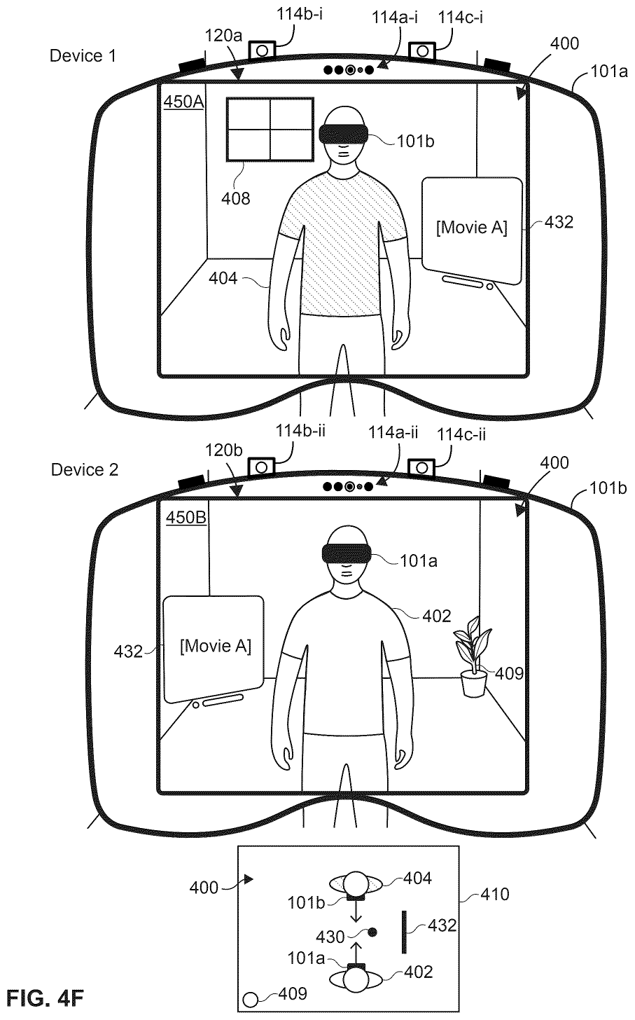

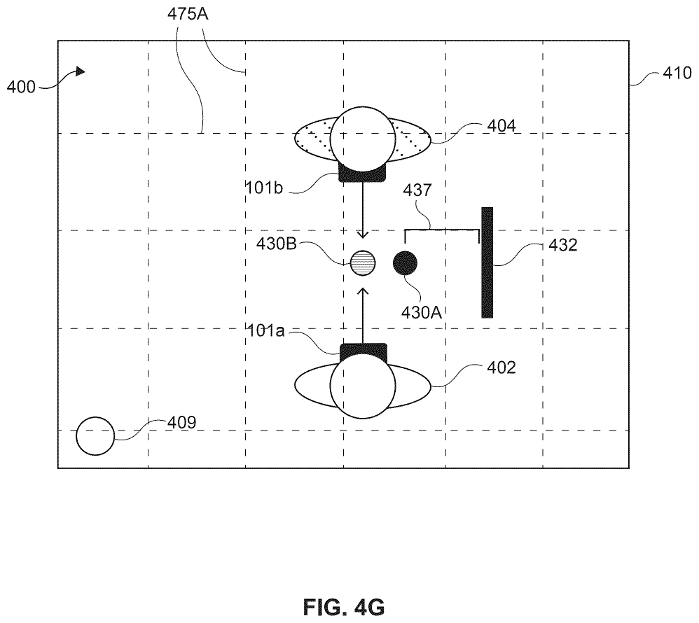

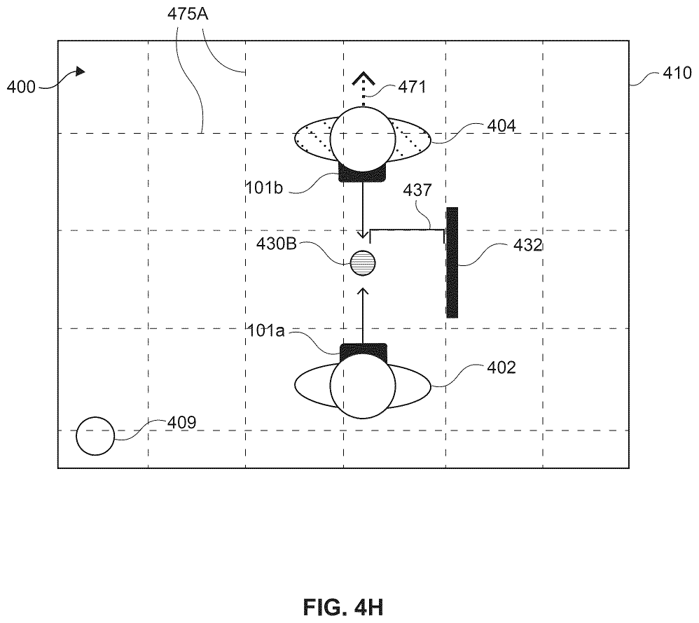

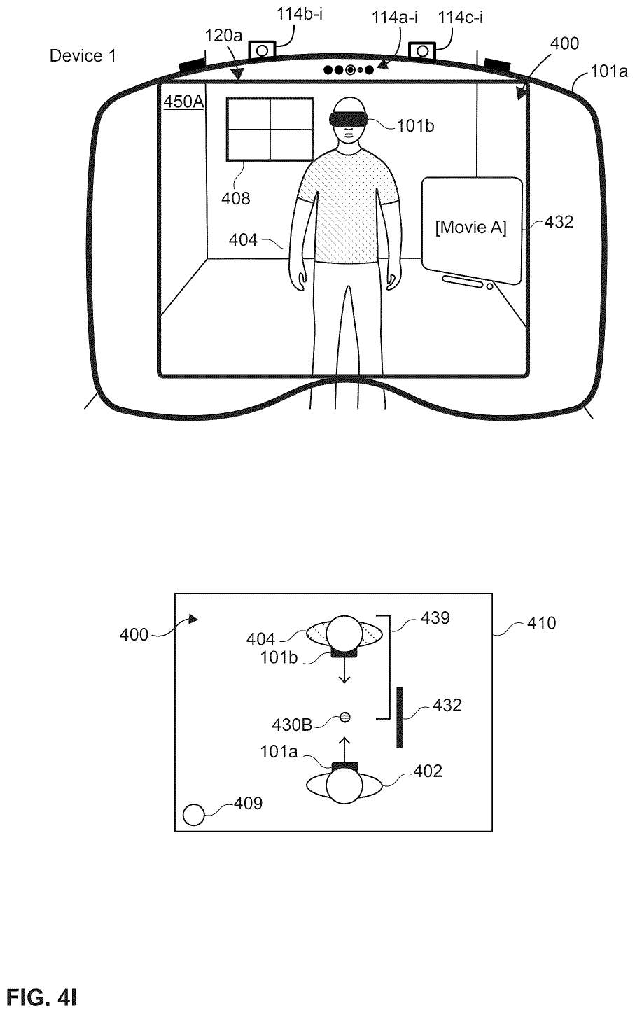

FIGS. 4A-4I illustrate exemplary techniques for establishing spatial truth for collocated participants within a spatial group in a multi-user communication session according to some examples of the disclosure. In some examples, as shown in FIG. 4A, three-dimensional environment 450A is presented using a first electronic device 101a (e.g., via display 120a) and three-dimensional environment 450B is presented using a second electronic device 101b (e.g., via display 120b). In some examples, the electronic devices 101a/101b optionally correspond to or are similar to electronic devices 360/370 discussed above and/or electronic devices 260/270 in FIG. 2. In some examples, as shown in FIG. 4A, the first electronic device 101a is being used by (e.g., worn on a head of) a first user 402 and the second electronic device 101b is being used by (e.g., worn on a head of) a second user 404.

In FIG. 4A, as indicated in overhead view 410, the first electronic device 101a and the second electronic device 101b are collocated in physical environment 400. For example, the first electronic device 101a and the second electronic device 101b are both located in a same room that includes physical window 408 and houseplant 409. In some examples, the determination that the first electronic device 101a and the second electronic device 101b are collocated in the physical environment 400 is based on a distance between the first electronic device 101a and the second electronic device 101b. For example, in FIG. 4A, the first electronic device 101a and the second electronic device 101b are collocated in the physical environment 400 because the first electronic device 101a is within a threshold distance (e.g., 0.1, 0.5, 1, 2, 3, 5, 10, 15, 20, etc. meters) of the second electronic device 101b. In some examples, the determination that the first electronic device 101a and the second electronic device 101b are collocated in the physical environment 400 is based on communication between the first electronic device 101a and the second electronic device 101b. For example, in FIG. 4A, the first electronic device 101a and the second electronic device 101b are configured to communicate (e.g., wirelessly, such as via Bluetooth, Wi-Fi, or a server (e.g., wireless communications terminal)). In some examples, the first electronic device 101a and the second electronic device 101b are connected to a same wireless network in the physical environment 400. In some examples, the determination that the first electronic device 101a and the second electronic device 101b are collocated in the physical environment 400 is based on a strength of a wireless signal transmitted between the electronic device 101a and 101b. For example, in FIG. 4A, the first electronic device 101a and the second electronic device 101b are collocated in the physical environment 400 because a strength of a Bluetooth signal (or other wireless signal) transmitted between the electronic devices 101a and 101b is greater than a threshold strength. In some examples, the determination that the first electronic device 101a and the second electronic device 101b are collocated in the physical environment 400 is based on visual detection of the electronic devices 101a and 101b in the physical environment 400. For example, as shown in FIG. 4A, the second electronic device 101b is positioned in a field of view of the first electronic device 101a (e.g., because the second user 404 is standing in the field of view of the first electronic device 101a), which enables the first electronic device 101a to visually detect (e.g., identify or scan, such as via object detection/recognition or other image processing techniques) the second electronic device 101b (e.g., in one or more images captured by the first electronic device 101a, such as via external image sensors 114b-i and 114c-i). Similarly, as shown in FIG. 4A, the first electronic device 101a is optionally positioned in a field of view of the second electronic device 101b (e.g., because the first user 402 is standing in the field of view of the second electronic device 101b), which enables the second electronic device 101b to visually detect the first electronic device 101a (e.g., in one or more images captured by the second electronic device 101b, such as via external image sensors 114b-ii and 114c-ii).

In some examples, the three-dimensional environments 450A/450B include captured portions of the physical environment 400 in which the electronic devices 101a/101b are located. For example, because the first electronic device 101a and the second electronic device 101b are collocated in the physical environment 400, the three-dimensional environments 450A and 450B include the physical window 408 (e.g., a representation of the physical window) and the houseplant 409 (e.g., a representation of the houseplant), but from the unique viewpoints of the first electronic device 101a and the second electronic device 101b, as shown in FIG. 4A. In some examples, the representations can include portions of the physical environment 400 viewed through a transparent or translucent display of the electronic devices 101a and 101b. In some examples, the three-dimensional environments 450A/450B have one or more characteristics of the three-dimensional environments 350A/350B described above with reference to FIG. 3.

In some examples, as shown in FIG. 4B, in accordance with the determination that the first electronic device 101a and the second electronic device 101b are collocated in the physical environment 400 (e.g., according to any one or combination of factors discussed above), the first electronic device 101a displays (e.g., via the display 120a) visual affordance 428 in the three-dimensional environment 450A that is selectable to initiate a process to enter a multi-user communication session with the second electronic device 101b. In some examples, the first electronic device 101 displays the visual affordance 428 in the three-dimensional environment 450A in response to detecting attention (e.g., including gaze 425) of the first user 402 directed to the second user 404 (e.g., and/or the second electronic device 101b) in the three-dimensional environment 450A. In some examples, as shown in FIG. 4B, the first electronic device 101a displays the visual affordance 428 at a location in the three-dimensional environment 450A corresponding to a location of the second user 404 from the viewpoint of the first electronic device 101a. For example, as shown in FIG. 4B, the first electronic device 101a displays the visual affordance 428 above the second electronic device 101b and/or overlaid on the head of the second user 404 from the viewpoint of the first electronic device 101a. It should be understood that the first electronic device 101a alternatively displays the visual affordance 428 at alternative locations in the three-dimensional environment 450A, such as overlaid on a different portion of the second user 404 (e.g., the torso of the second user 404, an arm of the second user 404, a hand of the second user 404, etc.). Additionally in some examples, as shown in FIG. 4B, the visual affordance 428 includes and/or is displayed with text “Tap to connect” indicating to the first user 402 that the visual affordance 428 is selectable to initiate the process to enter a multi-user communication session with the second user 404. It should also be understood that, in some examples, the second electronic device 101b displays a visual affordance similar to visual affordance 428 in the three-dimensional environment 450B in the manner discussed above in accordance with a determination that the first electronic device 101a and the second electronic device 101b are collocated in the physical environment 400 (e.g., and/or that attention of the second user 404 is directed to the first user 402 and/or the first electronic device 101a in the three-dimensional environment 450B), as similarly discussed above.

In FIG. 4B, while the first electronic device 101a is collocated with the second electronic device 101b in the physical environment 400, the first electronic device 101a detects an indication of a request to enter a multi-user communication with the second electronic device 101b. For example, as shown in FIG. 4B, the first electronic device 101a detects a selection input directed to the visual affordance 428 in the three-dimensional environment 450A. In some examples, as shown in FIG. 4B, the selection input corresponds to an air gesture performed by a hand 403 of the first user 402 directed to the visual affordance 428. For example, as shown in FIG. 4B, the first electronic device 101a detects the hand 403 perform an air pinch gesture (e.g., in which an index finger and thumb of the hand 403 come together to form a pinch hand shape), optionally while the gaze 425 of the first user 402 is directed to the visual affordance 428 in the three-dimensional environment 450A. In some examples, the first electronic device 101a alternatively detects an air tap or touch gesture, a gaze dwell, a verbal command, or other input that indicates selection of the visual affordance 428 in the three-dimensional environment 450A.

In some examples, in response to detecting the selection of the visual indication 438, the first electronic device 101a transmits a request (e.g., directly or indirectly, such as wirelessly via a server) to the second electronic device 101b to enter a multi-user communication session. In some examples, as shown in FIG. 4C, when the second electronic device 101b receives the request to enter the multi-user communication session with the first electronic device 101a, the second electronic device 101b displays message element 420 (e.g., a notification) corresponding to the request to join the multi-user communication session with the first electronic device 101a in the three-dimensional environment 450B. In some examples, as shown in FIG. 4C, the message element 420 includes a first option 421 that is selectable to accept the request (e.g., and join the multi-user communication session with the first electronic device 101a) and a second option 422 that is selectable to deny the request (e.g., and forgo joining the multi-user communication session with the first electronic device 101a).

In FIG. 4C, the second electronic device 101b detects one or more inputs accepting the request to join the multi-user communication session with the first electronic device 101a. For example, in FIG. 4C, the second electronic device 101b detects a selection of the first option 421 in the message element 420. As an example, the second electronic device 101b detects an air pinch gesture directed to the first option 421. For example, as shown in FIG. 4C, the second electronic device 101b detects an air pinch performed by a hand 405 of the second user 404, optionally while a gaze 425 of the second user 404 are directed to the first option 421 in the three-dimensional environment 450B. It should be understood that, as similarly discussed above, additional or alternative inputs are possible, such as air tap gestures, gaze and dwell inputs, verbal commands, etc.

In some examples, in response to detecting the input accepting the request to join the multi-user communication session with the first electronic device 101a, the second electronic device 101b enters the multi-user communication session with the first electronic device 101a. In some examples, as discussed below, entering the multi-user communication session that includes the first electronic device 101a and the second electronic device 101b includes identifying/determining an origin (e.g., a first origin) in the physical environment 400 according to which virtual content (e.g., avatars, virtual application windows, three-dimensional models, etc.) is displayed in the shared three-dimensional environment of the multi-user communication session.

As similarly described above with reference to FIG. 3, while the first user 402 of the first electronic device 101a and the second user 404 of the second electronic device 101b are collocated in the physical environment 400 and while the first electronic device 101a is in the multi-user communication session with the second electronic device 101b, the first user 402 and the second user 404 may be in a first spatial group (e.g., a same spatial group) within the multi-user communication session. In some examples, the first spatial group has one or more characteristics of spatial group 340 discussed above with reference to FIG. 3. As similarly described above, while the first user 402 and the second user 404 are in the first spatial group within the multi-user communication session, the users have a first spatial arrangement in the shared three-dimensional environment (e.g., represented by the locations of and/or distance between the users 402 and 404 in the overhead view 410 in FIG. 4A) determined by the physical locations of the electronic devices 101a and 101b in the physical environment 400. Particularly, the first electronic device 101a and the second electronic device 101b experience spatial truth relative to each other as dictated by the physical locations of and/or orientations of the first user 402 and the second user 404, respectively.

In some examples, as shown in FIG. 4D, when the first electronic device 101a and the second electronic device 101b enter the multi-user communication session, the first electronic device 101a and the second electronic device 101b determine a first origin 430 in the physical environment 400, as shown in the overhead view 410. In some examples, the first origin 430 corresponds to an intermediate/preliminary origin in the physical environment 400 (e.g., an estimate of a geometric center of the first spatial group that includes the first electronic device 101a and the second electronic device 101b). In some examples, establishing an intermediate origin in the physical environment 400 provides for a power-effective approach to enabling participants in a multi-user communication session to begin sharing and/or interacting with virtual content in the shared three-dimensional environment, without, for example, first requiring the first electronic device 101a and the second electronic device 101b to complete a more comprehensive (e.g., in-depth) analysis of the physical space surrounding the first electronic device 101a and the second electronic device 101b. For example, as discussed below, the first origin 430 in FIG. 4D is determined by the first electronic device 101a and the second electronic device 101b using rough (e.g., estimate-heavy) localization techniques that enable the first user 402 and the second user 404 to, after entering the multi-user communication session, immediately begin sharing and interacting with virtual content that is viewable by the first user 402 and the second user 404. In some examples, as discussed in more detail later, following the determination of the first origin 430 (e.g., the intermediate/preliminary origin), the first electronic device 101a and the second electronic device 101b collaboratively generate a spatial map corresponding to the physical environment 400 that includes an updated (e.g., final) origin according to which virtual content is displayed and/or updated. In some examples, the generation of the spatial map corresponding to the physical environment 400 requires and/or involves more power-consuming and/or time-consuming localization techniques, as discussed in more detail below.

In some examples, determining the first origin 430 in the physical environment 400 illustrated in the overhead view 410 in FIG. 4D is based on visual detection of the first electronic device 101a and the second electronic device 101b. For example, using the external image sensors 114b-i and 114c-i, the first electronic device 101a performs object detection (e.g., or similar image processing technique) of the second electronic device 101b in FIG. 4D. Similarly, in some examples, using the external image sensors 114b-ii and 114c-ii, the second electronic device 101b performs object detection of the first electronic device 101a. In some examples, performing the object detection enables the first electronic device 101a and the second electronic device 101b to determine a rough (e.g., estimated) position and/or orientation of the other electronic device in the physical environment 400. For example, in FIG. 4D, the first electronic device 101a identifies an approximate position and/or orientation of the second electronic device 101b (e.g., and thus the second user 404) in the physical environment 400 based on the object detection of the second electronic device 101b in the three-dimensional environment 450A. Accordingly, using the approximate locations of the first electronic device 101a and the second electronic device 101b in the physical environment 400 (e.g., and thus the approximate distance between the two locations), the first electronic device 101a and the second electronic device 101b determine an estimated geometric center of the first spatial group, which corresponds to the first origin 430 shown in the overhead view 410 in FIG. 4D.

In some examples, the visual detection discussed above additionally or alternatively includes scanning/identification of an image visible in the shared three-dimensional environment associated with the first electronic device 101a or the second electronic device 101b. For example, as shown in FIG. 4D, when the multi-user communication session is initiated between the first electronic device 101a and the second electronic device 101b, the second electronic device 101b presents, on the display 120b of the second electronic device 101b (e.g., on an outward facing surface of the display 120b), image 435 that is visually detectable by the first electronic device 101a (e.g., via the external image sensors 114b-i and 114c-i), but not necessarily visible to the first user 402. In some examples, as shown in FIG. 4D, the image 435 includes or corresponds to a scannable code, such as a barcode or quick-response (QR) code. However, it should be understood that the image 435 corresponds to any reference image that is detectable (e.g., scannable/readable) by the first electronic device 101a. In some examples, the image 435 corresponds to a visual encoding of a pose/transform (e.g., position and/or orientation) of the second electronic device 101b in the physical environment 400 as perceived by the second electronic device 101b (e.g., based on sensor data, such as image sensors 114aii-114cii). Accordingly, in some examples, when the first electronic device 101a visually detects (e.g., identifies) the image 435 in the three-dimensional environment 450A, the first electronic device 101a is able to access, via the image 435, information identifying the position and/or orientation of the second electronic device 101b relative to the first electronic device 101a, for example (e.g., and/or as opposed to the first electronic device 101a determining/calculating the position and/or orientation of the second electronic device 101b itself). It should also be understood that, in some examples, the first electronic device 101a similarly displays a reference image similar to image 435 (e.g., but unique to the first electronic device 101a) on the outward facing/external surface of the display 120a) that is visible to and detectable by the second electronic device 101b (e.g., via the external image sensors 114b-ii and 114c-ii).

In some examples, determining the first origin 430 in the physical environment 400 illustrated in the overhead view 410 in FIG. 4D is based on analyzing one or more physical attributes of the physical environment 400. For example, when the first electronic device 101a and the second electronic device 101b enter the multi-user communication session, the first electronic device 101a and the second electronic device 101b analyze and/or identify dimensions of the physical environment, physical objects within the physical environment, a visual appearance (e.g., color and lighting characteristics) of the physical environment, etc., according to which the first origin 430 may be defined in the physical environment 400. In some examples, as similarly discussed above, the one or more physical attributes of the physical environment are analyzed using images captured by the first electronic device 101a (e.g., using the external image sensors 114b-i and 114c-i) and the second electronic device 101b (e.g., using the external image sensors 114b-ii and 114c-ii). In some examples, as discussed in more detail later, the one or more physical attributes of the physical environment 400 based on Simultaneous Localization and Mapping (SLAM) data exchanged between the first electronic device 101a and the second electronic device 101b (e.g., SLAM data individually stored on the electronic devices 101a and 101b or SLAM data stored on one of the electronic devices 101a and 101b).

In some examples, determining the first origin 430 in the physical environment 400 illustrated in the overhead view 410 in FIG. 4D is based on identifying one or more common (e.g., shared) surfaces and/or objects of the physical environment 400. For example, when the first electronic device 101a and the second electronic device 101b enter the multi-user communication session, the first electronic device 101a and the second electronic device 101b analyze the physical environment 400 to identify an object or surface that is visible (e.g., in passthrough) to both electronic devices 101a and 101b (e.g., detectable by the external image sensors 114a-i and 114b-i of the first electronic device 101a and the external image sensors 114a-ii and 114b-ii of the second electronic device 101b). In some examples, the one or more common surfaces of the physical environment 400 correspond to the walls of the physical room in which the first electronic device 101a and the second electronic device 101b are located. Particularly, in the example of FIG. 4D, the one or more common surfaces correspond to one or more walls that are visible and located in the field of view of both electronic devices 101a and 101b, such as the left and/or right side walls of the physical room (e.g., relative to the viewpoints of the first electronic device 101a and the second electronic device 101b). In some examples, the one or more common surfaces correspond to and/or include one or more physical objects in the physical environment 400. For example, the one or more common surfaces correspond to and/or include a surface of the physical window 408 and/or a surface of the houseplant 409 in the physical environment 400. In some examples, the first origin 431 is determined to be approximately equidistant from the side walls of the physical room and/or a predefined distance from the physical window 408 or the houseplant 409. In some examples, the above approach of identifying one or more common surfaces and/or objects in the physical environment 400 optionally does not require communication between the first electronic device 101a and the second electronic device 101b, thereby helping conserve computing resources and power, as one advantage. For example, the first electronic device 101a and the second electronic device 101b independently analyze the physical environment 400 to determine that the surfaces are common to both the electronic devices 101a and 101b (e.g., the first electronic device 101a identifies the side walls of the physical room as being in its field and view approximates that the same side walls are also in the field of view of the second electronic device 101b (and vice versa)), without the first electronic device 101a and the second electronic device 101b exchanging data corresponding to such analysis. In some such examples, the common object need be visible and located in the field of view of both electronic devices 101a and 101b. For example, in FIG. 4D, the physical window 408 is located in the field of view of the first electronic device 101a in the three-dimensional environment 450A, but is not located in the field of view of the second electronic device 101b in the three-dimensional environment 450B. In such an instance, the first electronic device 101a and/or the second electronic device 101b may display a visual indication (e.g., a notification or other alert) that prompts the first user 402 and/or the second user 404 to move (e.g., shift and/or rotate) their head to locate the indicated common surface, thereby causing the common surface to become visible in the field of view of both the first electronic device 101a and the second electronic device 101b. For example, the first electronic device 101a displays a notification with a message “Locate the houseplant” in the three-dimensional environment 450A and/or the second electronic device 101b displays a notification with a message “Locate the window” in the three-dimensional environment 450B, but this may require the first electronic device 101a and the second electronic device 101b to communicate (e.g., the second electronic device 101b transmits data indicating to the first electronic device 101a that the houseplant 409 is located in the field of view of the second electronic device 101b and/or the first electronic device 101a transmits data indicating to the second electronic device 101b that the physical window 408 is located in the field of view of the first electronic device 101a).

It should be understood that, in some examples, the first origin 430 in FIG. 4D is determined using any one or combination of the approaches discussed above.

In some examples, after the first electronic device 101a and the second electronic device 101b determine the first origin 430 in the physical environment 400, a first (e.g., intermediate/approximated) shared coordinate space/system is defined for the first spatial group (e.g., a synchronized coordinate space having a first level of accuracy and/or confidence). For example, as indicated in the overhead view 410 in FIG. 4D, the first electronic device 101a is located at a first location relative to the first origin 430 of the first spatial group and the second electronic device 101b is located at a second location, different from the first location, relative to the first origin 430. Furthermore, the first electronic device 101a is located a first distance from the first origin 430 and the second electronic device 101b is located a second distance (e.g., different from or equal to the first distance) from the first origin 430. Additionally, as discussed below, in some examples, the first origin 430 enables virtual content (e.g., shared applications, user interfaces, three-dimensional objects/models, etc.) that is presented in the shared three-dimensional environment to be positioned at a same location within the first spatial group for all participants (e.g., by positioning the virtual content relative to the first origin 430).

In FIG. 4E, the first electronic device 101a detects an input corresponding to a request to share content with the second user 404 in the multi-user communication session. As shown in FIG. 4E, the first electronic device 101a is optionally displaying user interface element 424 that is associated with a media player application (e.g., a movie player application). In some examples, the user interface element 424 includes one or more selectable options for sharing content (e.g., Movie A) in the multi-user communication session. For example, as shown in FIG. 4E, the user interface element 424 includes selectable option 426 that is selectable to share Movie A with the second user 404 in the multi-user communication session (e.g., “User 2”).

In FIG. 4E, while displaying the user interface element 424, the first electronic device 101a detects an input corresponding to a selection of the selectable option 426. For example, as shown in FIG. 4E, the first electronic device 101a detects an air pinch gesture performed by the hand 403 of the first user 402, optionally while the gaze 425 of the first user 402 is directed to the selectable option 426.

In some examples, in response to detecting the selection of the selectable option 426, the first electronic device 101a initiates a process to display a shared virtual object in the shared three-dimensional environment. For example, in FIG. 4F, the first electronic device 101a and the second electronic device 101b determine a placement location for virtual object 432 corresponding to the shared content. In some examples, as indicated in the overhead view 410 in FIG. 4F, the virtual object 432 is displayed at a first location within the first spatial group relative to the first origin 430. As shown in FIG. 4F, the first electronic device 101a and the second electronic device 101b present the virtual object 432 in the three-dimensional environments 450A and 450B, respectively, according to the placement location of the virtual object 432 indicated in the overhead view 410. For example, as shown in FIG. 4F, the first electronic device 101a displays, via the display 120a, the virtual object 432 in front of the second user 404 and to the right of the viewpoint of the first electronic device 101a in the three-dimensional environment 450A and the second electronic device 101b displays, via the display 120b, the virtual object 432 in front of the first user 402 and to the left of the viewpoint of the second electronic device 101b in the three-dimensional environment 450B. In some examples, as shown in FIG. 4F, the virtual object 432 corresponds to and/or includes a virtual playback user interface that is displaying Movie A. In some examples, the virtual object 432 has one or more characteristics of shared virtual object 310 discussed above with reference to FIG. 3.

In some examples, as mentioned previously above, after determining the first origin 430 in the physical environment 400 (e.g., an approximated center of the first spatial group or other location corresponding to a location in the physical environment 400), the first electronic device 101a and the second electronic device 101b communicate to collaboratively generate a shared spatial map corresponding to the physical environment 400. For example, the first electronic device 101a and the second electronic device 101b utilize more power and/or time-consuming localization approaches to determine a second (e.g., updated/final) origin in the physical environment 400 that optionally corresponds to a more accurate and/or true convergence point in the physical environment 400. Additionally, in some examples, the first origin 430 in the physical environment may, due to the rough estimation techniques discussed above, correspond to slightly different physical locations (e.g., and/or surfaces) in the physical environment 400, which results in less precise spatial truth between the first electronic device 101a and the second electronic device 101b. For example, the first origin 430 may correspond to a first location in the physical environment 400 for the first electronic device 101a but may correspond to a second location, different from the first location, in the physical environment 400 for the second electronic device 101b, optionally resulting in the virtual object 432 (and/or other shared content) being displayed and/or visible at slightly different locations within the shared three-dimensional environment. As discussed below, determining the second origin in the physical environment 400 enables the slightly misaligned first origins 430 at the first electronic device 101a and the second electronic device 101b to converge to the same physical location.

In some examples, as shown in the overhead view 410 in FIG. 4G, the first electronic device 101a and the second electronic device 101b generate spatial map 475A corresponding to the physical environment 400. In some examples, as shown in FIG. 4G, the spatial map 475A includes second origin 430B (e.g., updated origin), different from the first origin 430A (e.g., corresponding to first origin 430 discussed above). In some examples, as illustrated by the grid pattern of the spatial map 475A, the spatial map 475A includes information corresponding to positions and/or orientations of physical objects in the physical environment 400, such as the houseplant 409, a size (e.g., dimensions) of the physical room of the physical environment 400, positions and/or orientations of the participants of the multi-user communication session in the physical environment (e.g., of the first user 402 and the second user 404), and/or positions and/or orientations of virtual content shared in the multi-user communication session (e.g., virtual object 432), relative to the second origin 430B. It should be understood that the spatial map 475A is optionally not displayed in and/or visible in the shared three-dimensional environment.

In some examples, the first electronic device 101a and the second electronic device 101b generate the spatial map 475A by synchronizing to a respective spatial map of a plurality of spatial maps corresponding to a plurality of physical environments, including the physical environment 400, that is accessible from a repository of spatial maps. For example, the spatial map 475A is previously generated (e.g., by the first electronic device 101a, the second electronic device 101b, or a different electronic device) and is specifically associated with the physical environment 400. In some examples, the repository of spatial maps includes spatial maps that are made accessible to the first electronic device 101a and/or the second electronic device 101b by one or more entities. For example, the spatial map 475A is owned, operated, and/or created by an owner or leaser of the physical space in which the first electronic device 101a and the second electronic device 101b are located, such as an organization, company, school, government agency, etc. In some examples, the repository of spatial maps is stored in memory of the first electronic device 101a and/or the second electronic device 101b. In some examples, the repository of spatial maps is stored in cloud storage or in a server that is accessible by the first electronic device 101a and/or the second electronic device 101b (e.g., while the first electronic device 101a and/or the second electronic device 101b are located in the physical environment 400). In the example of FIG. 4G, the first electronic device 101a and the second electronic device 101b access the spatial map 475A from memory and/or download the spatial map 475A from the cloud storage or other server while and/or after the virtual object 432 is displayed in the three-dimensional environment 450A/450B as discussed above.

In some examples, the spatial map 475A need only be accessible by one of the first electronic device 101a and the second electronic device 101b. For example, if the spatial map 475A is accessible by the first electronic device 101a, the first electronic device 101a may transmit data to the second electronic device 101b that enables the second electronic device 101b to synchronize to the spatial map 475A and establish the first spatial group as being relative to the second origin 430B (and vice versa). In some examples, the spatial map 475A is generated based on and/or includes SLAM data, as previously discussed above.

In some examples, the first electronic device 101a and the second electronic device 101b generate the spatial map 475A by exchanging time synchronization data associated with the current transforms (e.g., orientations and/or positions) of the first electronic device 101a and the second electronic device 101b in the physical environment 400. As mentioned previously above, when determining the first origin 430A (e.g., first origin 430 above) in the physical environment 400, the first electronic device 101a and the second electronic device 101b perform one or more image processing techniques, such as object detection, to determine a rough (e.g., estimated) understanding of a position and/or orientation of the other electronic device (and therefore its associated user) in the physical environment 400. For example, as described previously above, the first electronic device 101a identifies a position and/or orientation of the second electronic device 101b relative to the viewpoint of the first electronic device 101a, and the second electronic device 101b similarly identifies a position and/or orientation of the first electronic device 101a relative to the viewpoint of the second electronic device 101b. In some examples, generating the spatial map 475A includes exchanging data that includes information corresponding to the position and/or orientation of the electronic devices 101a and 101b at particular time intervals and synchronizing the data to determine the “true” position and/or orientation of the electronic devices 101a and 101b in the physical environment 400, as discussed below.

As an example, referring back to FIG. 4D, the first electronic device 101a, as mentioned above, determines that the second electronic device 101a has a first position and a first orientation in the physical environment 400 relative to the viewpoint of the first electronic device 101a. Additionally, the first electronic device 101a determines the second electronic device 101b has the first position and the first orientation at a respective time and/or over a respective interval of time. In FIG. 4G, the first electronic device 101a optionally transmits first data (e.g., directly or indirectly, such as via a server) to the second electronic device 101b that includes information corresponding to the position (e.g., the first position) and the orientation (e.g., the first orientation) of the second electronic device 101a as detected/determined by the first electronic device 101a (e.g., via one or more sensors of the first electronic device 101a) at the respective time and/or over the respective interval of time. Additionally, when the first electronic device 101a transmits the first data to the second electronic device 101b, the first electronic device 101a optionally transmits an indication of a request for second data from the second electronic device 101b. In some examples, the second data includes information corresponding to the position and the orientation of the second electronic device 101a as detected/determined by the second electronic device 101b (e.g., via one or more sensors of the second electronic device 101b) at the respective time and/or over the respective interval of time. In other words, the second electronic device 101b transmits data back to the first electronic device 101a that indicates the position and the orientation that the second electronic device 101b detected itself as having at the same moment in time and/or over the same interval of time that the first electronic device 101a detected the second electronic device 101b as having the first position and the first orientation in the physical environment 400 as discussed above. In some examples, when the first electronic device 101a receives (e.g., directly or indirectly) the second data from the second electronic device 101b, the first electronic device 101a synchronizes its understanding of the position and orientation of the second electronic device 101b to the own understanding of the position and orientation of the second electronic device 101b in the physical environment 400 by comparing the first data to the second data. It should be understood that similar approach is optionally conducted by the second electronic device 101b to synchronize the understanding of the position and orientation of the first electronic device 101a in the physical environment 400. The above approach enables the first electronic device 101a and the second electronic device 101b to determine the true (e.g., most accurate and/or more accurate) transforms (e.g., position and orientation) of the other electronic device in the physical environment 400, thereby enabling the first electronic device 101a and the second electronic device 101b to determine the second origin 430B (e.g., updated origin) in the physical environment 400 (e.g., by determining an updated distance between the first electronic device 101a and the second electronic device 101b based on their updated/true positions).

In some examples, after generating the spatial map 475A corresponding to the physical environment 400, the first electronic device 101a and the second electronic device 101b update positions of shared virtual content within the shared three-dimensional environment based on the spatial map 475A. For example, as shown in the overhead view 410 in FIG. 4G, the virtual object 432 discussed previously above is displayed a first distance 437 from the first origin 430A in the shared three-dimensional environment when the virtual object 432 is first displayed. In some examples, as discussed below, after the spatial map 475A is generated, the virtual object 432 is updated to be displayed relative to the second origin 430B in the physical environment 400, rather than (e.g., and no longer) being displayed relative to the first origin 430A in the physical environment 400.

In some examples, as shown in the overhead view 410 in FIG. 4H, when the display of the virtual object 432 is updated based on the spatial map 475A, the virtual object 432 is moved/shifted to be displayed the first distance 437 from the second origin 430B, rather than being displayed the first distance 437 from the first origin 430A shown in FIG. 4G. Accordingly, in some examples, when the display of the virtual object 432 is updated in the manner illustrated in the overhead view 410 in FIG. 4H, the virtual object 432 is shifted leftward relative to the viewpoint of the first electronic device 101a and is shifted rightward relative to the viewpoint of the second electronic device 101b (e.g., by the same magnitude (e.g., of distance)). Further interactions with the virtual object 432, such as movement and/or rotation of the virtual object 432, performed in response to user input and/or the display of additional or alternative shared virtual objects in the shared three-dimensional environment are therefore also conducted using the second origin 430B as a reference, enabling the first user 402 and the second user 404 to experience spatial truth within the first spatial group, which facilitates improved user experience and user perception of the virtual content, as one advantage.

In some examples, the first electronic device 101a and the second electronic device 101b update the spatial map 475A (e.g., and/or generate a new spatial map) that includes an updated origin (e.g., a third origin) according to which spatial truth is defined within the multi-user communication session in response to detecting a “drift” event. In some examples, a drift event corresponds to a user input or other user interaction that causes the established origin (e.g., second origin 430B) in the physical environment to no longer correspond to or represent a true/reliable convergence point (e.g., synchronized location within the physical environment) of the spatial group of the participants. In some examples, as discussed herein, detecting a drift event includes detecting movement of one or more of the electronic devices 101a/101b that causes at least one of the electronic devices 101a/101b to be located more than a threshold distance (e.g., 0.5, 1, 2, 3, 5, 10, 12, etc. meters) from the second origin 430B. In some examples, the threshold distance corresponds to a distance that is sufficiently large so as to cause the electronic device (e.g., the first electronic device 101a and/or the second electronic device 101b) to no longer effectively and/or reliably track and/or determine its pose (e.g., position and/or orientation) relative to the second origin 430B (e.g., such that tracking of the pose falls below a confidence threshold). One or more features of the physical environment optionally contribute to the drift event as well. For example, lighting of the physical environment (e.g., based on the location(s) of light source(s) relative to the viewpoint of the first electronic device 101a or the second electronic device 101b, visibility of physical surfaces/feature points in the physical environment, such as the common surface that serves as the location of the origin as previously discussed above, etc. may hinder the ability of the first electronic device 101a or the second electronic device 101b to measure its pose relative to the second origin 430B. In some examples, as discussed in more detail later, detecting a drift event includes detecting an indication that a new participant has joined the multi-user communication session. In some examples, a drift event may be detected after determining the first origin 430A/430 discussed above (e.g., and prior to and/or while generating the spatial map 475A). In some examples, a drift event may be detected after generating the spatial map 475A that includes the second origin 430B.

In FIG. 4H, the second electronic device 101b detects movement of the viewpoint of the second electronic device 101b relative to the second origin 430B in the physical environment 400. For example, as indicated by arrow 471 in the overhead view 410 in FIG. 4H, the second user 404 moves (e.g., walks) backward in space (e.g., away from the second origin 430B and the first user 402), which causes the viewpoint of the second electronic device 101b to be shifted away from the second origin 430B in the physical environment 400.

In some examples, as shown in FIG. 4I, the view of the three-dimensional environment 450A is updated in accordance with the movement of the second user 404 and the second electronic device 101a from the viewpoint of the first electronic device 101a. For example, as shown in FIG. 4I, the second user 404 and the second electronic device 101b are located farther from the viewpoint of the first electronic device 101a in the three-dimensional environment 450A in accordance with the movement of the second user 404 discussed above.

As mentioned previously above, in some examples, movement of one or more electronic devices in a multi-user communication session corresponds to a drift event that causes the electronic devices to generate an updated spatial map corresponding to the physical environment in which the electronic devices are located. As illustrated in the overhead view 410 in FIG. 4I, the movement of the second user 404 does not cause the second electronic device 101b to be located more than threshold distance 439 from the second origin 430B in the physical environment 400. Accordingly, the movement of the second user 404 and the second electronic device 101b illustrated in FIGS. 4H-4I optionally does not correspond to a drift event. As such, the first electronic device 101a and the second electronic device 101b forgo generating a new/updated spatial map corresponding to the physical environment 400 that includes a new/updated origin according to which spatial truth is defined.

Accordingly, as outlined above, providing systems and methods for establishing spatial truth among collocated participants in a multi-user communication session enables virtual objects (e.g., avatars and/or virtual content) to be displayed in a shared three-dimensional environment of the multi-user communication session, which advantageously enables the collocated participants to experience synchronized interaction with content and other participants, thereby improving user-device interaction. Additionally, automatically determining an origin according to which the virtual objects (e.g., avatars and/or virtual content) are displayed in the shared three-dimensional environment reduces and/or helps avoid user input for manually selecting the origin in the shared three-dimensional environment, which helps conserve computing resources that would otherwise be consumed to respond to such user input, as another benefit. Attention is now directed toward examples of drift events that cause the first electronic device and the second electronic device to generate updated spatial maps for reestablishing spatial truth a multi-user communication session.

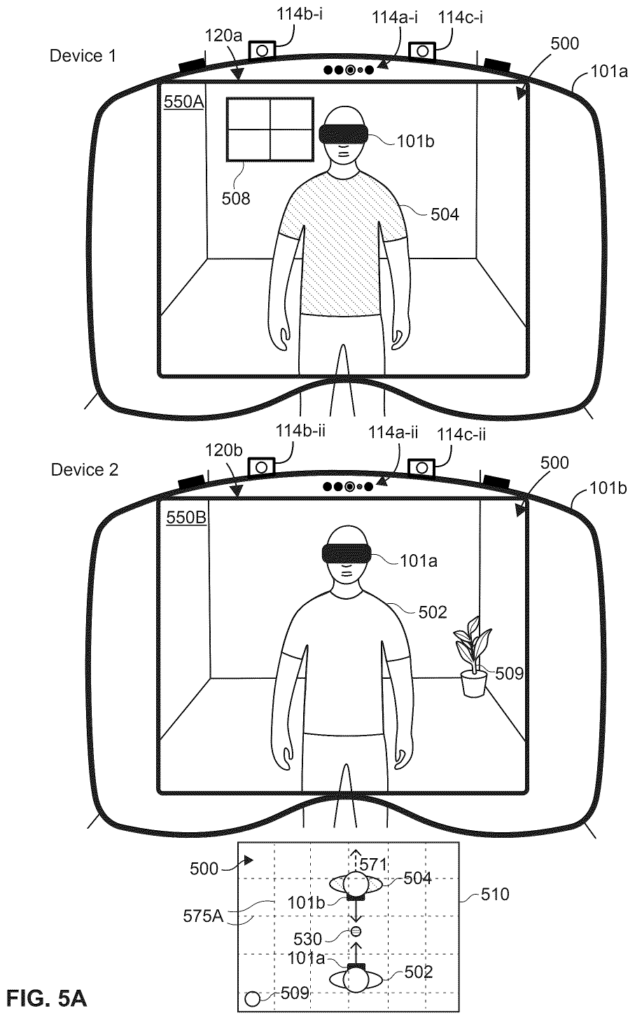

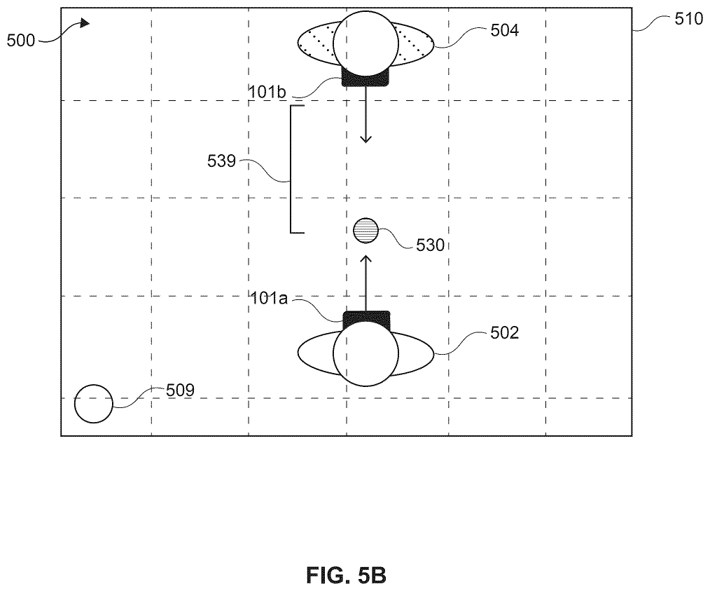

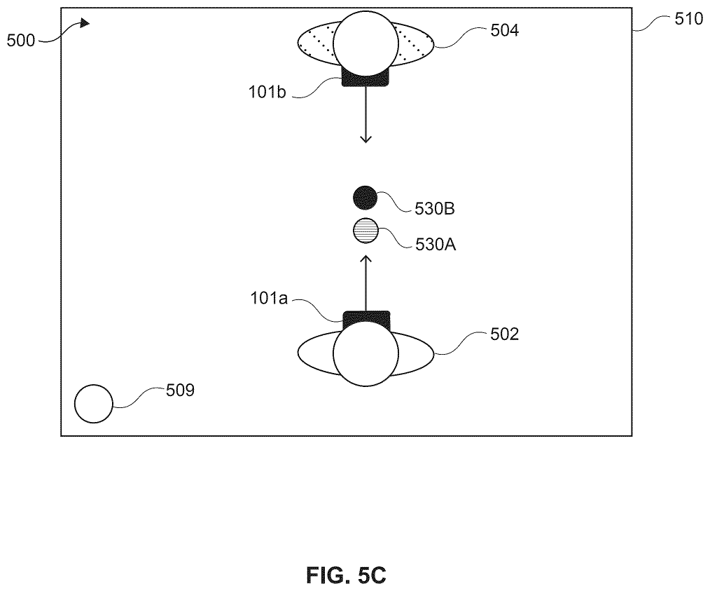

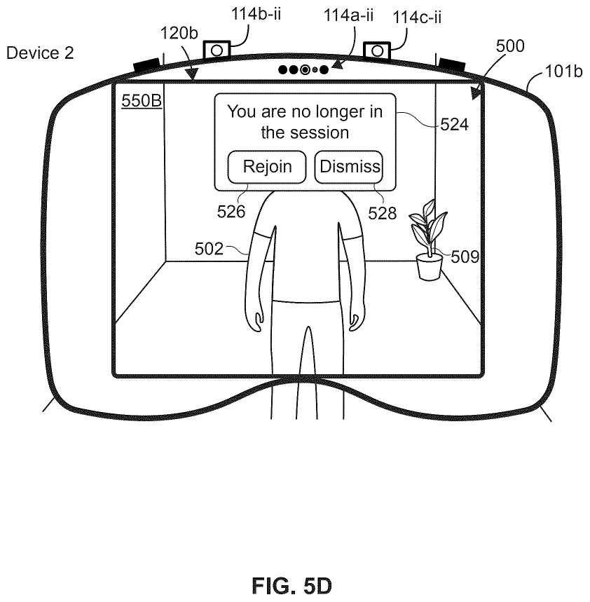

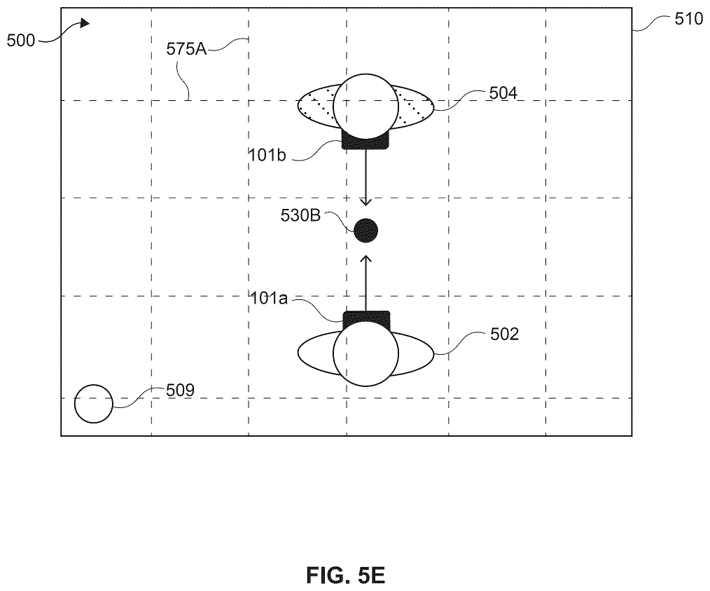

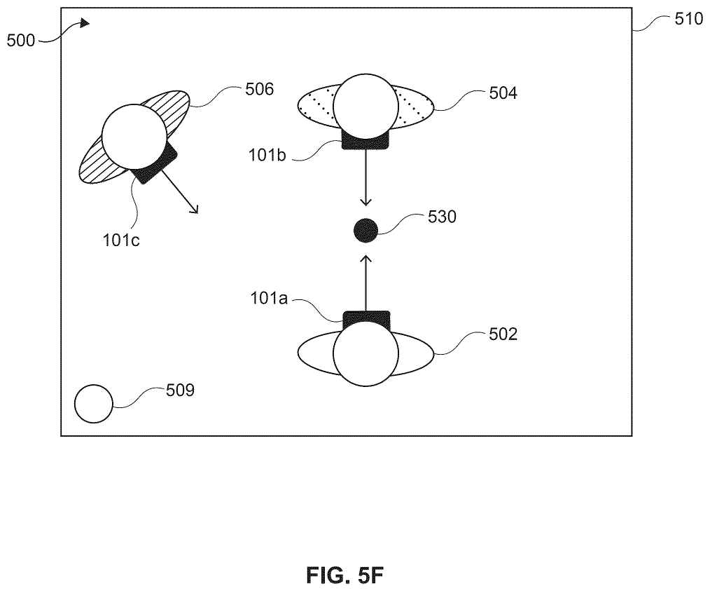

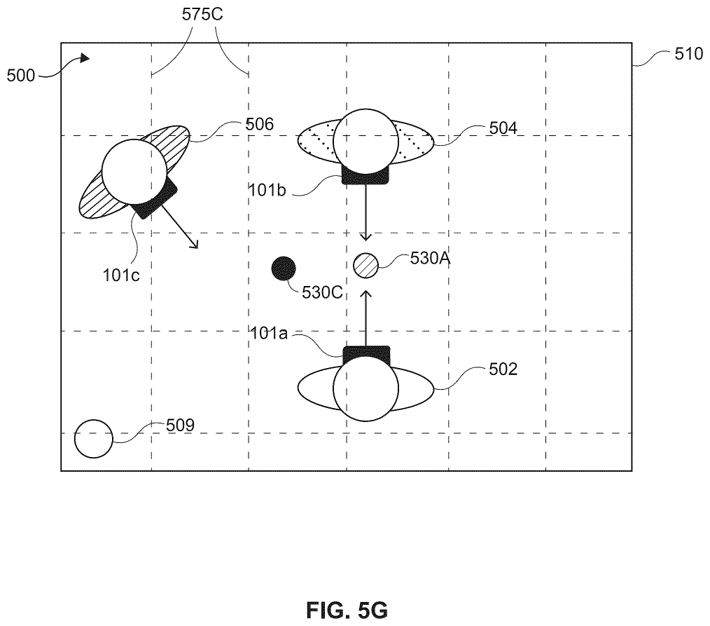

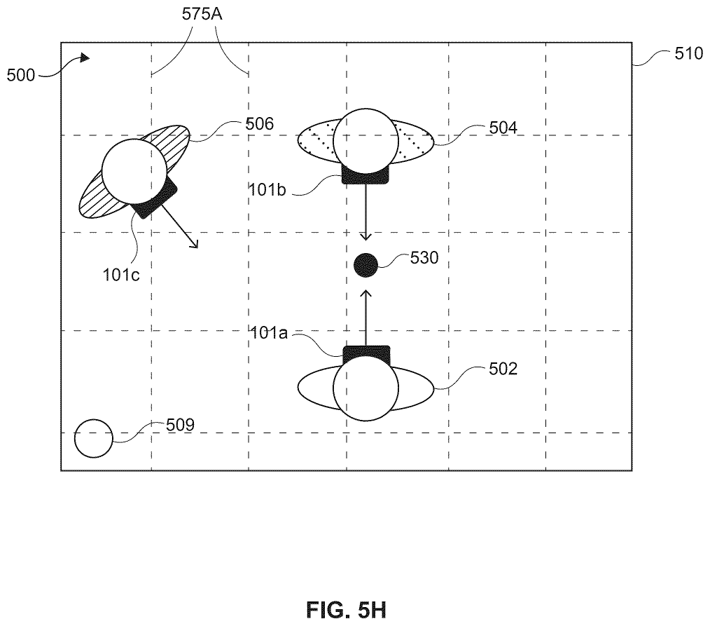

FIGS. 5A-5H illustrate exemplary techniques for reestablishing spatial truth for collocated participants within a spatial group in a multi-user communication session according to some examples of the disclosure. In FIG. 5A, first electronic device 101a (e.g., associated with first user 502) and second electronic device 101b (e.g., associated with second user 504) are collocated in physical environment 500, as similarly discussed above. In some examples, the first user 502 and the second user 504 correspond to first user 402 and second user 404, respectively, of FIGS. 4A-4I. In some examples, physical environment 500 corresponds to physical environment 400 of FIGS. 4A-4I.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of the physical environment 500 of the first electronic device 101a. For example, as shown in overhead view 510 in FIG. 5A, the physical environment 500 corresponds to a room that includes physical window 508 and houseplant 509. Accordingly, as shown in FIG. 5A, the three-dimensional environment 550A presented using the first electronic device 101a includes a representation of the physical window 508 (e.g., the physical window 508 is visible in a field of view of the first electronic device 101a). Additionally, as shown in FIG. 5A, the second user 504 (e.g., and the second electronic device 101b) is currently visible in the three-dimensional environment 550A from a current viewpoint of the first electronic device 101a. In some examples, the three-dimensional environment 550A has one or more characteristics of three-dimensional environment 450A discussed above.

Similarly, as shown in FIG. 5A, the second electronic device 101b is presenting (e.g., via display 120b) three-dimensional environment 550B. In FIG. 5A, as similarly discussed above, the three-dimensional environment 550B includes representations (e.g., passthrough representations or computer-generated representations) of the physical environment 500 of the second electronic device 101b. For example, as shown in FIG. 5A, the three-dimensional environment 550B presented using the second electronic device 101b includes a representation of the houseplant 509 (e.g., the houseplant 509 is visible in a field of view of the second electronic device 101b). Additionally, as shown in FIG. 5A, the first user 502 (e.g., and the first electronic device 101a) is currently visible in the three-dimensional environment 550B from a current viewpoint of the second electronic device 101b. In some examples, the three-dimensional environment 550B has one or more characteristics of three-dimensional environment 450B discussed above.

In the example of FIG. 5A, the first electronic device 101a and the second electronic device 101b are in a multi-user communication session, as similarly discussed above. For example, as discussed above with reference to FIGS. 4A-4I, the first electronic device 101a (e.g., and the first user 402) and the second electronic device 101b (e.g., and the second user 404) are in a first spatial group within the multi-user communication session. Particularly, as indicated in the overhead view 510 in FIG. 5A, the first electronic device 101a and the second electronic device 101b have generated spatial map 575A corresponding to the physical environment 500 and that includes origin 530 according to which spatial truth is defined in the first spatial group. In some examples, the spatial map 575A has one or more characteristics of the spatial map 475A discussed above. In some examples, the origin 530 has one or more characteristics of second origin 430B discussed above.

In FIG. 5A, the second electronic device 101b detects movement of the viewpoint of the second electronic device 101b relative to the origin 530 in the physical environment 500. For example, as indicated by arrow 571 in the overhead view 510 in FIG. 5A, the second user 504 moves (e.g., walks) backward in space (e.g., away from the origin 530 and the first user 502), which causes the viewpoint of the second electronic device 101b to be shifted away from the origin 530 in the physical environment 500.

As mentioned previously above, in some examples, movement of one or more electronic devices in a multi-user communication session may lead to a drift event that causes the electronic devices to generate an updated spatial map corresponding to the physical environment in which the electronic devices are located. As illustrated in the overhead view 510 in FIG. 5B, the movement of the second user 504 causes the second electronic device 101b to be located more than threshold distance 539 (e.g., corresponding to threshold distance 439 above) from the origin 530 in the physical environment 500 (e.g., and/or causes the second electronic device 101b to no longer be able to effectively track its pose (e.g., position and/or orientation) relative to the origin 530 (e.g., such that tracking of the pose falls below a confidence threshold)). Accordingly, the movement of the second user 504 and the second electronic device 101b illustrated in FIG. 5B optionally leads to a drift event. As such, as discussed below, the first electronic device 101a and the second electronic device 101b initiate a process to generate a new/updated spatial map corresponding to the physical environment 500 that includes a new/updated origin according to which spatial truth is defined.

In some examples, in response to detecting the drift event discussed above (e.g., the movement of the second electronic device 101b more than the threshold distance from the origin 530 in the physical environment 500), the first electronic device 101a and the second electronic device 101b determine an updated origin in the physical environment 500. For example, as illustrated in the overhead view 510 in FIG. 5C, the first electronic device 101a and the second electronic device 101b determine updated origin 530B in the physical environment 500, which is different from the origin 530A (e.g., corresponding to origin 530 in FIGS. 5A-5B). In some examples, the updated origin 530B is determined using the same or similar approaches discussed above with reference to FIGS. 4A-4I. For example, the first electronic device 101a and the second electronic device 101b perform one or more image processing techniques, such as object detection, analyze one or more physical characteristics of the physical environment 500, and/or identify one or more common surfaces and/or objects in the physical environment to generate a rough localization of the current positions and/or orientations of the first electronic device 101a and the second electronic device 101b in the physical environment 500. In some examples, the first electronic device 101a and the second electronic device 101b continue to communicate to collaboratively generate a SLAM characterization of the physical environment 500 (e.g., according to which spatial truth within further and/or subsequent multi-user communication sessions in the physical environment 500 is able to be established).

Subsequently, as discussed above with reference to FIGS. 4A-4I, the first electronic device 101a and the second electronic device 101b generate an updated spatial map corresponding to the physical environment 500 that includes the updated position and/or orientation of the second electronic device 101b. Particularly, the first electronic device 101a and the second electronic device 101b optionally utilize a time synchronization approach as previously discussed above to identify the relative positions and/or orientations of the first electronic device 101a and the second electronic device 101b at a particular instance in time and/or over a particular interval of time. In the manner discussed above, the first electronic device 101a and the second electronic device 101b generate the updated origin 530B according to which spatial truth is reestablished in the first spatial group in the multi-user communication session.

In some examples, the above-described approach for reestablishing spatial truth for the first electronic device 101a and the second electronic device 101b in response to detecting a drift event is performed automatically by the first electronic device 101a and the second electronic device 101b. Alternatively, in some examples, the first electronic device 101a and the second electronic device 101b initiate the process to reestablish spatial truth (e.g., generating an updated spatial map that includes an updated origin) in response to specifically detecting user input corresponding to such a request. For example, as shown in FIG. 5D, after the second electronic device 101b detects the movement of the viewpoint of the second electronic device 101b that causes the second electronic device 101b to be located more than the threshold distance from the origin 530 in FIG. 5B, the second electronic device 101b displays message element 524 in the three-dimensional environment 550B. As shown in FIG. 5D, the message element 524 optionally indicates to the second user 504 that the movement of the second user 504 (e.g., and the second electronic device 101b) has caused the second user 504 to no longer be in the multi-user communication session. Additionally, as shown in FIG. 5D, in some examples, the message element 524 includes a first option 526 that is selectable to allow the second user 504 to rejoin the multi-user communication session and reestablish spatial truth based on the current position and/or orientation of the second electronic device 101b in the physical environment 500. In some examples, as shown in FIG. 5D, the message element 524 includes a second option 528 that is selectable to forgo rejoining the multi-user communication session and reestablishing spatial truth based on the current position and/or orientation of the second electronic device 101b in the physical environment 500. In FIG. 5C, the second electronic device 101b optionally detects a selection input (e.g., air pinch gesture, air tap gesture, air touch gesture, verbal command, etc.) directed to the first option 526 in the message element 524.

In some examples, as mentioned previously above, detecting a drift event that causes the first electronic device 101a and the second electronic device 101b to generate an updated spatial map corresponding to the physical environment 500 includes detecting a new user (e.g., a third user) join the multi-user communication session. For example, in FIG. 5E, while the first user 502 and the second user 504 are in the first spatial group, as indicated in the overhead view 510, the first electronic device 101a and the second electronic device 101b are governing interactions based on the spatial truth defined according to origin 530B in the physical environment 500 of the spatial map 575A. In some examples, while the first user 502 and the second user 504 are in the multi-user communication session, a third user joins the multi-user communication session, as illustrated in the overhead view 510 in FIG. 5F. For example, as shown in FIG. 5F, third user 506 (e.g., who is wearing third electronic device 101c) has entered (e.g., or is otherwise now located in) the physical space of the physical environment 500 (e.g., such that the third electronic device 101c is collocated with the first electronic device 101a and the second electronic device 101b in the physical environment 500). Additionally, in some examples, in FIG. 5F, while the third electronic device 101c is collocated with the first electronic device 101a and the second electronic device 101b in the physical environment 500, the first electronic device 101a and/or the second electronic device 101b detect an indication of a request from the third electronic device 101c to join the multi-user communication session that includes the first electronic device 101a and the second electronic device 101b. For example, the third electronic device 101c detects a sequence of one or more inputs corresponding to a request to join the multi-user communication session that includes the first electronic device 101a and the second electronic device 101b, such as the inputs discussed above with reference to FIGS. 4A-4B. The first electronic device 101a and/or the second electronic device 101b optionally display an indication of the request enabling the first user 502 and/or the second user 504 to approve the request, similar to message element 420 in FIG. 4C.

In some examples, when the third electronic device 101c joins the multi-user communication session that includes the first electronic device 101a and the second electronic device 101b, the first electronic device 101a and the second electronic device 101b detect that a drift event has occurred, as similarly discussed above. In some examples, in response to detecting that the drift event has occurred, the first electronic device 101a, the second electronic device 101b, and the third electronic device 101c generate an updated spatial map 575C that includes updated origin 530C (e.g., different from origin 530A), as illustrated in the overhead view 510 in FIG. 5G, as similarly discussed above. For example, as shown in the overhead view 510 in FIG. 5G, the first electronic device 101a, the second electronic device 101b, and the third electronic device 101c collaborate to update the origin in the physical environment 500 to incorporate the position and/or the orientation of the third electronic device 101c (e.g., and the third user 506) in the manner discussed previously above (e.g., by performing one or more image processing techniques to identify the position and/or orientation of the third electronic device 101c relative to the viewpoints of the first electronic device 101a and the second electronic device 101b and/or perform time synchronization to the position and/or orientation of the third electronic device 101c as detected by the third electronic device 101c itself). It should be understood that, when generating the updated spatial map 575C, an intermediate origin (e.g., similar to first origin 430 discussed previously above) is optionally determined prior to determining the updated origin 530C as previously discussed above with reference to FIG. 4D, but is not illustrated in FIG. 5G for brevity.

In some examples, after the updated spatial map 575C is generated, as illustrated in the overhead view 510 in FIG. 5G, the first electronic device 101a, the second electronic device 101b, and the third electronic device 101c experience spatial truth within the first spatial group relative to the updated origin 530C (e.g., corresponding to an updated/true center of the locations of the users 502-506 as similarly discussed above). Accordingly, as discussed previously above, content that is shared and presented in the multi-user communication session is displayed within the shared three-dimensional environment relative to the updated origin 530C, enabling interactions with the shared content to be synchronized among the three users 502-506, thereby improving the overall user experience. Additionally, as previously discussed above with reference to FIGS. 4G-4H, in some examples, if the first electronic device 101a and the second electronic device 101b were already displaying shared content (e.g., such as virtual object 432) when the drift event discussed above was detected (e.g., the third electronic device 101c joining the multi-user communication session), the shared content would be redisplayed/repositioned (e.g., shifted and/or rotated) in the shared three-dimensional environment relative to the viewpoints of the first electronic device 101a and the second electronic device 101b when the updated spatial map 575C is generated, such that the shared content is now displayed relative to the updated origin 530C (e.g., and no longer relative to the origin 530A). In such an instance, the third electronic device 101c optionally displays the shared content relative to the updated origin 530C in the first spatial group (e.g., rather than displaying the shared content relative to the origin 530A and updating display of the shared content to be displayed relative to the updated origin 530C).

In some examples, rather than generate an updated spatial map in response to detecting the drift event corresponding to the third user 506 (e.g., and the third electronic device 101c) joining the multi-user communication session, the existing spatial map (e.g., spatial map 575A in FIG. 5E) is shared with the third electronic device 101c, which enables the third electronic device 101c to establish spatial truth with the first electronic device 101a and the second electronic device 101b using the existing spatial map. For example, as illustrated in the overhead view 510 in FIG. 5H, rather than generate an updated spatial map that includes an updated origin when the third electronic device 101c joins the multi-user communication session that includes the first electronic device 101a and the second electronic device 101b, the third electronic device 101c synchronizes to the spatial map 575A that has already been generated by the first electronic device 101a and the second electronic device 101b. In some examples, map data corresponding to the spatial map 575A is transmitted (e.g., directly or indirectly) to the third electronic device 101c from the first electronic device 101a and/or the second electronic device 101b. In some examples, the map data includes or corresponds to SLAM data of the physical environment 500, as discussed previously above. In some examples, the first electronic device 101a and the second electronic device 101b forgo initiating the process to update the spatial map 575A when the third electronic device 101c joins the multi-user communication session in accordance with a determination that the spatial map 575A corresponds to a respective spatial map of a plurality of spatial maps corresponding to a plurality of physical environments, including the physical environment 500, that is accessible from a repository of spatial maps, as previously discussed herein. For example, the third electronic device 101c downloads and/or otherwise accesses the map data from the repository when joining the multi-user communication session (e.g., from cloud storage or from memory). Accordingly, after the third electronic device 101c joins the multi-user communication session, in the example of FIG. 5H, spatial truth for the first electronic device 101a, the second electronic device 101b, and the third electronic device 101c continues to be defined relative to the origin 530 in the physical environment 500. Additionally, in some examples, the first electronic device 101a, the second electronic device 101b, and the third electronic device 101c can communicate to collaboratively update the spatial map 575A as needed, such as in response to detecting further drift events and/or other input-based occurrences.

Accordingly, as outlined above, providing systems and methods for reestablishing spatial truth among collocated participants in a multi-user communication session in response to detecting a drift event enables virtual objects (e.g., avatars and/or virtual content) to continue to be displayed in the shared three-dimensional environment of the multi-user communication session after detecting the drift event, which advantageously enables the collocated participants to continue experiencing synchronized interaction with content and other participants, thereby improving user-device interaction. Additionally, automatically updating an origin according to which the virtual objects (e.g., avatars and/or virtual content) are displayed in the shared three-dimensional environment in response to detecting the drift event reduces and/or helps avoid user input for manually selecting an updated origin in the shared three-dimensional environment, which helps conserve computing resources that would otherwise be consumed to respond to such user input, as another benefit.

It is understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. For example, the virtual objects representative of application windows (e.g., virtual objects 330 and 432) may be provided in an alternative shape than a rectangular shape, such as a circular shape, triangular shape, etc. In some examples, the various selectable options (e.g., options 421 and 422), user interface elements (e.g., message element 420 or user interface element 424), etc. described herein may be selected verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

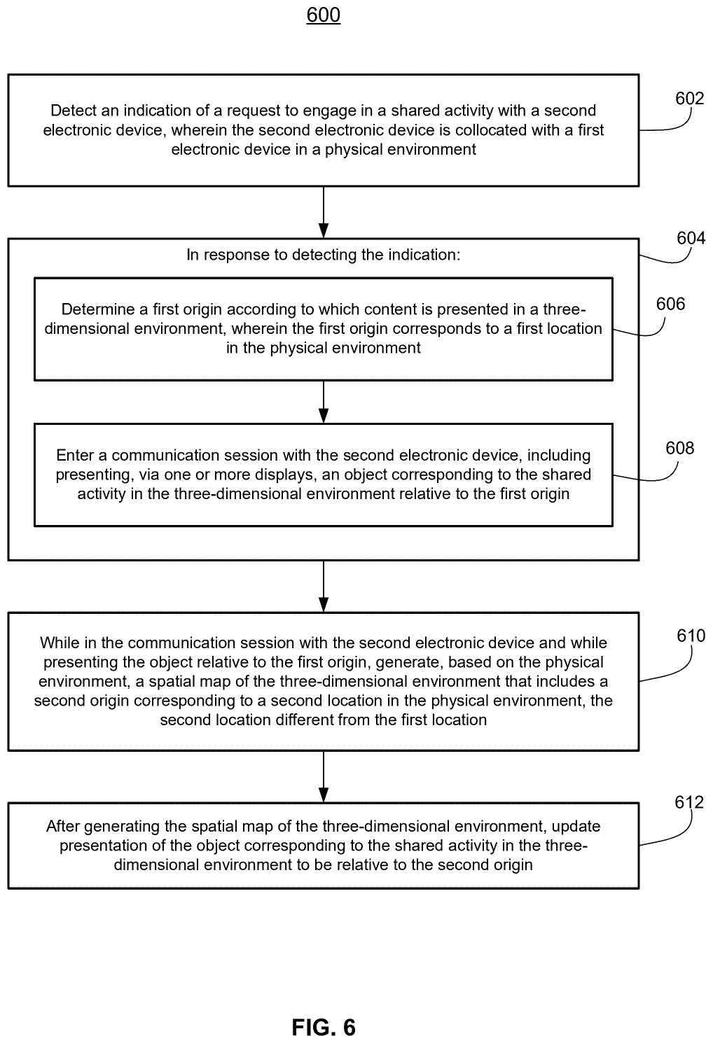

FIG. 6 illustrates a flow diagram illustrating an example process for establishing spatial truth for collocated participants in a spatial group in a multi-user communication session according to some examples of the disclosure. In some examples, process 600 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 6, in some examples, at 602, the first electronic device detects an indication of a request to engage in a shared activity with the second electronic device. For example, as shown in FIGS. 4B-4C, first electronic device 101a detects user input corresponding to a request to enter a multi-user communication session with second electronic device 101b. Additionally, in some examples, as shown in FIG. 4E, the first electronic device 101a detects user input corresponding to a request to share content (e.g., Movie A) with the second electronic device 101b in the multi-user communication session.

In some examples, at 604, in response to detecting the indication, at 606, the first electronic device determines a first origin according to which content is presented in a three-dimensional environment, wherein the first origin corresponds to a first location in the physical environment. For example, as illustrated in overhead view 410 in FIG. 4E, the first electronic device 101a determines first origin 430 in physical environment 400. In some examples, at 608, the first electronic device enters a communication session with the second electronic device, including presenting, via the one or more displays, an object corresponding to the shared activity in the three-dimensional environment relative to the first origin. For example, as shown in FIG. 4F, while in the multi-user communication session with the second electronic device 101b, the first electronic device 101a displays virtual object 432 in three-dimensional environment 450A relative to the first origin 430, as indicated in the overhead view 410.

In some examples, at 610, while in the communication session with the second electronic device and while presenting the object relative to the first origin, the first electronic device generates, based on the physical environment, a spatial map of the three-dimensional environment that includes a second origin corresponding to a second location in the physical environment, the second location different from the first location. For example, as illustrated in the overhead view 410 in FIG. 4G, the first electronic device 101a generates spatial map 475A that includes second origin 430B (e.g., different from first origin 430A) in the physical environment 400. In some examples, at 612, after generating the spatial map of the three-dimensional environment, the first electronic device updates presentation of the object corresponding to the shared activity in the three-dimensional environment to be relative to the second origin. For example, as shown in the overhead view 410 in FIG. 4H, the virtual object 432 is repositioned in the shared three-dimensional environment to be first distance 437 from the second origin 430B (e.g., and no longer to be the first distance 437 from the first origin 430A in FIG. 4G).

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising at a first electronic device in communication with one or more displays and one or more input devices, wherein the first electronic device is collocated with a second electronic device in a physical environment: detecting an indication of a request to engage in a shared activity with the second electronic device; in response to detecting the indication, determining a first origin according to which content is presented in a three-dimensional environment, wherein the first origin corresponds to a first location in the physical environment, and entering a communication session with the second electronic device, including presenting, via the one or more displays, an object corresponding to the shared activity in the three-dimensional environment relative to the first origin; while in the communication session with the second electronic device and while presenting the object relative to the first origin, generating, based on the physical environment, a spatial map of the three-dimensional environment that includes a second origin corresponding to a second location in the physical environment, the second location different from the first location; and after generating the spatial map of the three-dimensional environment, updating presentation of the object corresponding to the shared activity in the three-dimensional environment to be relative to the second origin.

Additionally or alternatively, in some examples, the first electronic device being collocated with the second electronic device in the physical environment comprises the second electronic device being within a threshold distance of the first electronic device in the physical environment. Additionally or alternatively, in some examples, the second electronic device being collocated with the first electronic device in the physical environment comprises the second electronic device being located in a field of view of the first electronic device. Additionally or alternatively, in some examples, the second electronic device being collocated with the first electronic device in the physical environment comprises the second electronic device being located in a same physical room as the first electronic device. Additionally or alternatively, in some examples, the first origin is determined using a first environment analysis technique, and the second origin is determined using a second environment analysis technique, different from the first environment analysis technique. Additionally or alternatively, in some examples, the first origin is determined based on performing object recognition of the second electronic device. Additionally or alternatively, in some examples, the first origin is determined based on visually detecting, via the one or more input devices, an image associated with the second electronic device that is visible in the physical environment from a viewpoint of the first electronic device. Additionally or alternatively, in some examples, the first origin is determined based on analyzing one or more physical characteristics of the physical environment. Additionally or alternatively, in some examples, the first origin is determined based on identifying a physical reference in the physical environment that is identifiable by the second electronic device. Additionally or alternatively, in some examples, the second origin is determined by synchronizing the spatial map of the three-dimensional environment to a respective spatial map of a plurality of spatial maps corresponding to a plurality of physical environments, including the physical environment, that is accessible from a repository of spatial maps.

Additionally or alternatively, in some examples, the second origin is determined based on first data provided by the second electronic device. Additionally or alternatively, in some examples, the first data provided by the second electronic device includes information corresponding to a position of the second electronic device relative to the first origin and an orientation of the second electronic device relative to the first origin. Additionally or alternatively, in some examples, the first origin is determined based on identifying a position of the second electronic device relative to a viewpoint of the first electronic device and an orientation of the second electronic device relative to the viewpoint of the first electronic device over a first time period, and the first data provided by the second electronic device is captured by the second electronic device over the first time period. Additionally or alternatively, in some examples, the method further comprises: while in the communication session with the second electronic device and while presenting the object relative to the second origin, detecting that a respective event has occurred; and in response to detecting that the respective event has occurred, in accordance with a determination that the respective event satisfies one or more criteria, updating the spatial map to include a third origin corresponding to a third location in the physical environment, the third location different from the second location, and updating presentation of the object corresponding to the shared activity in the three-dimensional environment to be relative to the third origin. Additionally or alternatively, in some examples, detecting that the respective event has occurred includes detecting a change in position of the second electronic device relative to the second origin, and the one or more criteria include a criterion that is satisfied when the change in position of the second electronic device causes the second electronic device to be located more than a threshold distance from the second origin.

Additionally or alternatively, in some examples, detecting that the respective event has occurred includes detecting a change in pose of the first electronic device relative to the second origin, and the one or more criteria include a criterion that is satisfied when the change in pose of the first electronic device causes a synchronization of the second origin between the first electronic device and the second electronic device to fall below a confidence threshold. Additionally or alternatively, in some examples, detecting that the respective event has occurred includes detecting a change in a number of participants in the communication session, and the one or more criteria include a criterion that is satisfied when the change in the number of participants in the communication session corresponds to an increase in the number of participants in the communication session. Additionally or alternatively, in some examples, after detecting the increase in the number of participants in the communication session, the communication session further includes a third electronic device that is collocated with the first electronic device and the second electronic device in the physical environment, the method further comprising: while in the communication session with the second electronic device and the third electronic device, and while presenting the object relative to the third origin, detecting, via the one or more input devices, a first input corresponding to a request to leave the communication session; in response to detecting the first input, ceasing display of the object in the three-dimensional environment; after leaving the communication session, detecting, via the one or more input devices, a second input corresponding to a request to rejoin the communication session that includes the second electronic device and the third electronic device; and in response to detecting the second input, synchronizing to a respective spatial map of the three-dimensional environment that includes a respective origin, and presenting, via the one or more displays, the object at a respective location in the three-dimensional environment relative to the respective origin.

Additionally or alternatively, in some examples, the method further comprises: while in the communication session with the second electronic device and while presenting the object relative to the second origin, detecting an indication of a request to add a third electronic device to the communication session, wherein the third electronic device is collocated with the first electronic device and the second electronic device in the physical environment; and in response to detecting the indication, adding the third electronic device to the communication session, and maintaining presentation of the object relative to the second origin in the three-dimensional environment. Additionally or alternatively, in some examples, the indication of the request to engage in the shared activity with the second electronic device includes detecting, via the one or more input devices, an input corresponding to a request to share content with the second electronic device. Additionally or alternatively, in some examples, the indication of the request to engage in the shared activity with the second electronic device corresponds to user input detected by the second electronic device for sharing content with the first electronic device. Additionally or alternatively, in some examples, presenting the object corresponding to the shared activity in the three-dimensional environment relative to the first origin is in accordance with a determination that the first origin is determined with a first confidence level, and updating presentation of the object corresponding to the shared activity in the three-dimensional environment to be relative to the second origin is in accordance with a determination that the second origin is determined with a second confidence level, greater than the first confidence level.

Some examples of the disclosure are directed to a first electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of a first electronic device, cause the first electronic device to perform any of the above methods.

Some examples of the disclosure are directed to a first electronic device, comprising one or more processors, memory, and means for performing any of the above methods.

Some examples of the disclosure are directed to an information processing apparatus for use in a first electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices, wherein the first electronic device is collocated with a second electronic device in a physical environment:
detecting an indication of a request to engage in a shared activity with the second electronic device;
in response to detecting the indication:
determining a first origin according to which content is presented in a three-dimensional environment, wherein the first origin corresponds to a first location in the physical environment; and
entering a communication session with the second electronic device, including presenting, via the one or more displays, an object corresponding to the shared activity in the three-dimensional environment relative to the first origin;
while in the communication session with the second electronic device and while presenting the object relative to the first origin, generating, based on the physical environment, a spatial map of the three-dimensional environment that includes a second origin corresponding to a second location in the physical environment, the second location different from the first location; and
after generating the spatial map of the three-dimensional environment, updating presentation of the object corresponding to the shared activity in the three-dimensional environment to be relative to the second origin.

2. The method of claim 1, wherein the first electronic device being collocated with the second electronic device in the physical environment comprises:
the second electronic device being within a threshold distance of the first electronic device in the physical environment;
the second electronic device being located in a field of view of the first electronic device; and/or
the second electronic device being located in a same physical room as the first electronic device.

3. The method of claim 1, wherein:
the first origin is determined using a first environment analysis technique; and
the second origin is determined using a second environment analysis technique, different from the first environment analysis technique.

4. The method of claim 1, wherein the first origin is determined based on at least one of:
performing object recognition of the second electronic device;
visually detecting, via the one or more input devices, an image associated with the second electronic device that is visible in the physical environment from a viewpoint of the first electronic device;
analyzing one or more physical characteristics of the physical environment; and
identifying a physical reference in the physical environment that is identifiable by the second electronic device.

5. The method of claim 1, wherein the second origin is determined by synchronizing the spatial map of the three-dimensional environment to a respective spatial map of a plurality of spatial maps corresponding to a plurality of physical environments, including the physical environment, that is accessible from a repository of spatial maps.

6. The method of claim 1, wherein:
the second origin is determined based on first data provided by the second electronic device, the first data including information corresponding to a position of the second electronic device relative to the first origin and an orientation of the second electronic device relative to the first origin;
the first origin is determined based on identifying a position of the second electronic device relative to a viewpoint of the first electronic device and an orientation of the second electronic device relative to the viewpoint of the first electronic device over a first time period; and
the first data provided by the second electronic device is captured by the second electronic device over the first time period.

7. The method of claim 1, further comprising:
while in the communication session with the second electronic device and while presenting the object relative to the second origin, detecting that a respective event has occurred; and
in response to detecting that the respective event has occurred, in accordance with a determination that the respective event satisfies one or more criteria:
updating the spatial map to include a third origin corresponding to a third location in the physical environment, the third location different from the second location; and
updating presentation of the object corresponding to the shared activity in the three-dimensional environment to be relative to the third origin.

8. The method of claim 1, further comprising:
while in the communication session with the second electronic device and while presenting the object relative to the second origin, detecting an indication of a request to add a third electronic device to the communication session, wherein the third electronic device is collocated with the first electronic device and the second electronic device in the physical environment; and
in response to detecting the indication:
adding the third electronic device to the communication session; and
maintaining presentation of the object relative to the second origin in the three-dimensional environment.

9. A first electronic device comprising:
one or more processors;
memory; and
one or more programs stored in the memory and configured to be executed by the one or more processors, the one or more programs including instructions for performing a method comprising:
detecting an indication of a request to engage in a shared activity with a second electronic device, wherein the first electronic device is collocated with the second electronic device in a physical environment;
in response to detecting the indication:
determining a first origin according to which content is presented in a three-dimensional environment, wherein the first origin corresponds to a first location in the physical environment; and
entering a communication session with the second electronic device, including presenting, via one or more displays, an object corresponding to the shared activity in the three-dimensional environment relative to the first origin;
while in the communication session with the second electronic device and while presenting the object relative to the first origin, generating, based on the physical environment, a spatial map of the three-dimensional environment that includes a second origin corresponding to a second location in the physical environment, the second location different from the first location; and
after generating the spatial map of the three-dimensional environment, updating presentation of the object corresponding to the shared activity in the three-dimensional environment to be relative to the second origin.

10. The first electronic device of claim 9, wherein the first electronic device being collocated with the second electronic device in the physical environment comprises:
the second electronic device being within a threshold distance of the first electronic device in the physical environment;
the second electronic device being located in a field of view of the first electronic device; and/or
the second electronic device being located in a same physical room as the first electronic device.

11. The first electronic device of claim 9, wherein:
the first origin is determined using a first environment analysis technique; and
the second origin is determined using a second environment analysis technique, different from the first environment analysis technique.

12. The first electronic device of claim 9, wherein the first origin is determined based on at least one of:
performing object recognition of the second electronic device;
visually detecting, via one or more input devices, an image associated with the second electronic device that is visible in the physical environment from a viewpoint of the first electronic device;
analyzing one or more physical characteristics of the physical environment; and
identifying a physical reference in the physical environment that is identifiable by the second electronic device.

13. The first electronic device of claim 9, wherein the second origin is determined by synchronizing the spatial map of the three-dimensional environment to a respective spatial map of a plurality of spatial maps corresponding to a plurality of physical environments, including the physical environment, that is accessible from a repository of spatial maps.

14. The first electronic device of claim 9, wherein:
the second origin is determined based on first data provided by the second electronic device, the first data including information corresponding to a position of the second electronic device relative to the first origin and an orientation of the second electronic device relative to the first origin;
the first origin is determined based on identifying a position of the second electronic device relative to a viewpoint of the first electronic device and an orientation of the second electronic device relative to the viewpoint of the first electronic device over a first time period; and
the first data provided by the second electronic device is captured by the second electronic device over the first time period.

15. The first electronic device of claim 9, wherein the method further comprises:
while in the communication session with the second electronic device and while presenting the object relative to the second origin, detecting that a respective event has occurred; and
in response to detecting that the respective event has occurred, in accordance with a determination that the respective event satisfies one or more criteria:
updating the spatial map to include a third origin corresponding to a third location in the physical environment, the third location different from the second location; and
updating presentation of the object corresponding to the shared activity in the three-dimensional environment to be relative to the third origin.

16. The first electronic device of claim 9, wherein the method further comprises:
while in the communication session with the second electronic device and while presenting the object relative to the second origin, detecting an indication of a request to add a third electronic device to the communication session, wherein the third electronic device is collocated with the first electronic device and the second electronic device in the physical environment; and
in response to detecting the indication:
adding the third electronic device to the communication session; and
maintaining presentation of the object relative to the second origin in the three-dimensional environment.

17. A non-transitory computer readable storage medium storing one or more programs, the one or more programs comprising instructions, which when executed by one or more processors of a first electronic device, cause the first electronic device to perform a method comprising:
detecting an indication of a request to engage in a shared activity with a second electronic device, wherein the first electronic device is collocated with the second electronic device in a physical environment;
in response to detecting the indication:
determining a first origin according to which content is presented in a three-dimensional environment, wherein the first origin corresponds to a first location in the physical environment; and
entering a communication session with the second electronic device, including presenting, via one or more displays, an object corresponding to the shared activity in the three-dimensional environment relative to the first origin;
while in the communication session with the second electronic device and while presenting the object relative to the first origin, generating, based on the physical environment, a spatial map of the three-dimensional environment that includes a second origin corresponding to a second location in the physical environment, the second location different from the first location; and
after generating the spatial map of the three-dimensional environment, updating presentation of the object corresponding to the shared activity in the three-dimensional environment to be relative to the second origin.

18. The non-transitory computer readable storage medium of claim 17, wherein the first electronic device being collocated with the second electronic device in the physical environment comprises:
the second electronic device being within a threshold distance of the first electronic device in the physical environment;
the second electronic device being located in a field of view of the first electronic device;
and/or the second electronic device being located in a same physical room as the first electronic device.

19. The non-transitory computer readable storage medium of claim 17, wherein:
the first origin is determined using a first environment analysis technique; and
the second origin is determined using a second environment analysis technique, different from the first environment analysis technique.

20. The non-transitory computer readable storage medium of claim 17, wherein the first origin is determined based on at least one of:
performing object recognition of the second electronic device;
visually detecting, via one or more input devices, an image associated with the second electronic device that is visible in the physical environment from a viewpoint of the first electronic device;
analyzing one or more physical characteristics of the physical environment; and
identifying a physical reference in the physical environment that is identifiable by the second electronic device.

21. The non-transitory computer readable storage medium of claim 17, wherein the second origin is determined by synchronizing the spatial map of the three-dimensional environment to a respective spatial map of a plurality of spatial maps corresponding to a plurality of physical environments, including the physical environment, that is accessible from a repository of spatial maps.

22. The non-transitory computer readable storage medium of claim 17, wherein:
the second origin is determined based on first data provided by the second electronic device, the first data including information corresponding to a position of the second electronic device relative to the first origin and an orientation of the second electronic device relative to the first origin;
the first origin is determined based on identifying a position of the second electronic device relative to a viewpoint of the first electronic device and an orientation of the second electronic device relative to the viewpoint of the first electronic device over a first time period; and
the first data provided by the second electronic device is captured by the second electronic device over the first time period.

23. The non-transitory computer readable storage medium of claim 17, wherein the method further comprises:
while in the communication session with the second electronic device and while presenting the object relative to the second origin, detecting that a respective event has occurred; and
in response to detecting that the respective event has occurred, in accordance with a determination that the respective event satisfies one or more criteria:
updating the spatial map to include a third origin corresponding to a third location in the physical environment, the third location different from the second location; and
updating presentation of the object corresponding to the shared activity in the three-dimensional environment to be relative to the third origin.

24. The non-transitory computer readable storage medium of claim 17, wherein the method further comprises:
while in the communication session with the second electronic device and while presenting the object relative to the second origin, detecting an indication of a request to add a third electronic device to the communication session, wherein the third electronic device is collocated with the first electronic device and the second electronic device in the physical environment; and
in response to detecting the indication:
adding the third electronic device to the communication session; and
maintaining presentation of the object relative to the second origin in the three-dimensional environment.
